(19) United States
(12) Patent Application Publication
(10) Pub. No.: US 2014/0363610 A1
(43) Pub. Date: Dec. 11, 2014

(54) COMPRESSION, EXTRUSION AND INJECTION MOLDING OF INTERLOCKING DRY ADHESIVE MICROSTRUCTURES WITH FLEXIBLE MOLD TECHNOLOGY

(71) Applicant: Daniel Elliot SAMEOTO, Edmonton (CA)

(72) Inventor: Daniel Elliot SAMEOTO, Edmonton (CA)

(21) Appl. No.: 14/308,635

(22) Filed: Jun. 18, 2014

Related U.S. Application Data
(63) Continuation-in-part of application No. 14/187,927, filed on Feb. 24, 2014.
Application No. 14/187,927 is a continuation of application No. 12/905,065, filed on Oct. 14, 2010, now Pat. No. 8,703,032.
(60) Provisional application No. 61/251,667, filed on Oct. 14, 2009.
(60) Provisional application No. 61/292,835, filed on Jan. 6, 2010.
(60) Provisional application No. 61/836,573, filed on Jun. 18, 2013.

(51) Int. Cl. B29C 33/38; C09J 133/12; B29C 47/00; B29C 33/42; B29C 43/00; B29C 45/00

(52) U.S. Cl. CPC B29C 33/3842; B29C 43/003; B29C 45/0001; B29C 47/0004; B29C 33/42; C09J 133/12; B29K 2083/00
USPC 428/92; 264/313; 264/226

(57) ABSTRACT

Geometric configurations for interlocking cap and fiber structures of interlocking dry adhesive materials are disclosed. Various methods for manufacturing interlocking dry adhesive materials including using a flexible negative mold and thermoplastic polymer dry adhesive material are disclosed. Various methods of manufacturing directly molded anisotropic interlocking dry adhesive structures using thermoplastic polymer dry adhesive materials are also provided.

### CROSS-REFERENCE TO RELATED APPLICATIONS

This application is a continuation-in-part of U.S. patent application Ser. No. 14/187,927 filed Feb. 24, 2014 and entitled BIOMIMETIC DRY ADHESIVES AND METHODS OF PRODUCTION THEREFOR; which is a continuation of U.S. patent application Ser. No. 12/905,065 filed Oct. 14, 2010 and entitled BIOMIMETIC DRY ADHESIVES AND METHODS OF PRODUCTION THEREFOR; which claims priority to U.S. Provisional Patent Application No. 61/251,667 filed Oct. 14, 2009 and entitled DIRECT MOLDING OF DRY ADHESIVES WITH ANISOTROPIC PEEL STRENGTH USING OFFSET LIFT-OFF PHOTORESIST MOLD, and also claims priority to U.S. Provisional Patent Application No. 61/292,835 filed Jan. 6, 2010 and entitled BIOMEMETIC DRY ADHESIVES AND METHODS OF PRODUCTION THEREFOR.

This application also claims priority to U.S. Provisional Patent Application No. 61/836,573 filed Jun. 18, 2013 and entitled COMPRESSION, EXTRUSION AND INJECTION MOLDING OF INTERLOCKING DRY ADHESIVE MICROSTRUCTURES WITH FLEXIBLE MOLD TECHNOLOGY.

This application hereby incorporates by reference the contents of all of the above-referenced related applications in their entirety:

### FIELD OF THE INVENTION

The present invention relates generally to interlocking microstructures having undercut or overhanging interlocking features. More particularly, the present invention relates to compression, extrusion and injection molding of interlocking dry adhesive microstructures with flexible mold technology including dry adhesives and methods of production therefor involving photolithographically formed flexible molds.

### BACKGROUND TO THE INVENTION

Biomimetic dry adhesives are inspired by the fibrillar structures found on the feet of geckos and certain spiders. These adhesives have been investigated by multiple research groups for use in applications ranging from climbing robots, to use in surgical tools or bandages, for example. Microstructuring surfaces into dry adhesive fibers of other interlocking microstructures having either undercut or overhanging interlocking features has been shown to allow relatively stiff materials to be more pliant in order to make intimate contact with substrates so that van der Waals interactions can produce significant adhesion for exploitation in dry adhesive structures. One application is to develop biomimetic dry adhesives for use in space applications. Potential advantages of these types of adhesives for use in space is that dry adhesives may provide for operation in vacuum without problems of out-gassing encountered with traditional pressure sensitive adhesives (PSAs), and could potentially be used on almost any surface.

Biomimetic dry adhesives with mushroom shaped interlocking fibers have been found to be far more effective than their flat tipped counterparts for loading in the normal direction. While multiple groups have tested high aspect ratio fibers made of stiff polymers or carbon nanotubes, these adhesives generally perform much better in shear than with normal loads. In contrast, softer materials with mushroom shaped fibers demonstrate normal adhesion that is much greater than unstructured surfaces, and can have a high ratio of adhesion strength to pre-load. Multiple research groups have developed methods of producing mushroom shaped adhesive geometry, with fiber diameters ranging from <5 to >50 μm. In theory, these fibers operate primarily on van der Waals interactions between surfaces, and may operate effectively under vacuum. In practice, several groups have reported on performance degradation under low pressure conditions, or adhesion underwater—an unexpected occurrence if van der Waals forces are the primary cause of adhesion. In some such reports, the caps on the pillars were large (>40 μm).

In other applications which do not require adhesion of the dry adhesive in low-pressure environments, effective adhesives made of relatively soft materials (E˜1-10 MPa) have shown in experimental results that the shape of the fiber tip itself is dominant when determining maximum adhesion pressure, with mushroom shaped tips demonstrating the greatest effectiveness. Offset caps have been demonstrated such as by dipping and smearing flat fiber tips in fresh silicone, but their measured adhesion was less than that of aligned mushroom caps. More recently, angled tips have been used by different research groups to replicate some anisotropic behavior but these methods have required complex lithography or dipping techniques to define the molds or produce the final directional dry adhesives.

### SUMMARY OF THE INVENTION

According to one embodiment of the present invention, a method of manufacturing an interlocking dry adhesive structure comprising overhanging cap and undercut fiber structures is provided. In one such embodiment, the method comprises:
providing a flexible elastomer negative mold comprising negative interlocking dry adhesive structures comprising a plurality of negative overhanging cap and undercut fiber structures;
molding a thermoplastic dry adhesive polymer material in the flexible elastomer negative mold under application of heat and pressure;
allowing the thermoplastic dry adhesive polymer material to cool; and
flexibly demolding the flexible elastomer negative mold from the thermoplastic dry adhesive polymer material to release the interlocking dry adhesive structure comprising the overhanging cap and undercut fiber structures.

In another embodiment of the invention, the method may additionally comprise melting a thermoplastic dry adhesive polymer material before molding the thermoplastic dry adhesive polymer material in the flexible elastomer negative mold under application of heat and pressure. In a further embodiment, the step of molding according to the method may comprise at least one of compressive molding, injection molding and extrusion molding. In yet a further embodiment, the step of molding according to the method may comprise providing an extruded film of a thermoplastic dry adhesive polymer material, and molding the thermoplastic dry adhesive polymer material in a flexible elastomer negative mold roller under application of heat and pressure. In another embodiment, a thermoplastic interlocking dry adhesive structure comprising overhanging cap and undercut fiber structures is provided, where the thermoplastic interlocking dry adhesive structure is formed by the above-described method.

According to another embodiment of the present invention, a method of manufacturing a thermoplastic interlocking dry adhesive structure comprising overhanging cap and undercut fiber structures is provided, in which the method comprises:
applying a photoresistive material to a photosensitive mold substrate comprising polymethyl methacrylate;
patterning and developing the photoresistive material to form a mask comprising the overhanging cap structures corresponding to the dry adhesive structure;
exposing the mask and the photoresistive mold substrate to UV light to pattern the photoresistive mold substrate;
developing the mold substrate to form the undercut fiber structures substantially aligned with and supporting the overhanging cap structures corresponding to the dry adhesive structure;
molding a flexible elastomer material in the mold substrate to form a flexible elastomer negative mold comprising a plurality of negative overhanging cap and undercut fiber structures; and
molding a thermoplastic polymer dry adhesive material in the flexible elastomer negative mold under heat and pressure to form the thermoplastic interlocking dry adhesive structure comprising the overhanging cap and undercut fiber structures.

In another embodiment, the step of molding a thermoplastic polymer dry adhesive material according to the method may comprise at least one of compressive molding, injection molding and extrusion molding. In a further embodiment, the step of patterning and developing the photoresistive material to form a mask may comprise patterning the photoresistive material comprising at least one of: direct printing, stamping and lithography. In another embodiment, a thermoplastic interlocking dry adhesive structure comprising overhanging cap and undercut fiber structures is provided, where the thermoplastic interlocking dry adhesive structure is formed by the above-described method.

In an alternative embodiment, the method may comprise depositing, embossing, stamping or otherwise patterning a non-photosensitive material onto the mold substrate to form a mask comprising the undercut cap structures corresponding to the dry adhesive structure.

According to another embodiment of the present invention, a thermoplastic interlocking dry adhesive structure consisting of a flexible thermoplastic polymer material is provided. In one such embodiment, the flexible thermoplastic polymer interlocking dry adhesive structure may comprise:
a base structure;
a plurality of fiber structures extending from the base structure and having an aspect ratio of at least 1:1; and
a plurality of cap structures corresponding to and situated atop the undercut fiber structures wherein the cap structures substantially overhang the fiber structures on at least one side.

In an alternative embodiment of the thermoplastic interlocking dry adhesive structure according to the present invention, the plurality of fiber structures extending from the base structure may desirably have an aspect ratio of at least 2:1, and in a further embodiment, of at least 3:1.

### BRIEF DESCRIPTION OF THE DRAWINGS

FIG. 1 illustrates a schematic view of a manufacturing process for manufacturing interlocking dry adhesive structures according to an embodiment of the present invention.

FIG. 2 illustrates a scanning electron microscope (SEM) image of an acrylic mold substrate according to an embodiment of the present invention.

FIG. 3 illustrates optical microscope images of an acrylic mold substrate according to an embodiment of the present invention.

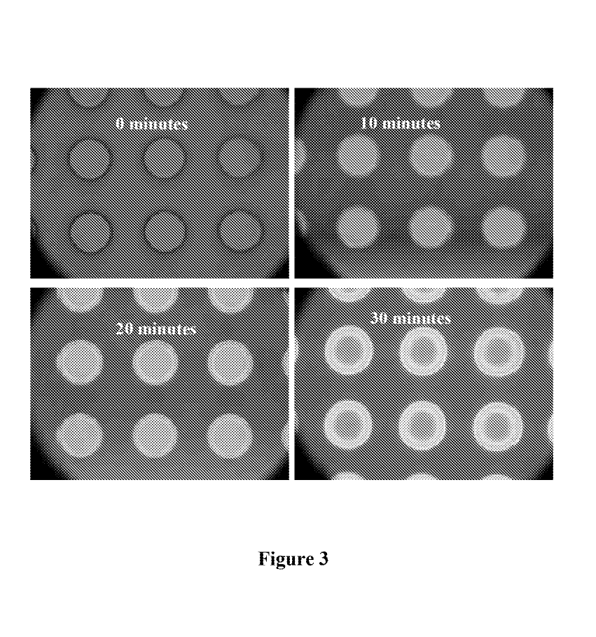

FIG. 4 illustrates an SEM image of an interlocking dry adhesive structure manufactured according to an embodiment of the present invention.

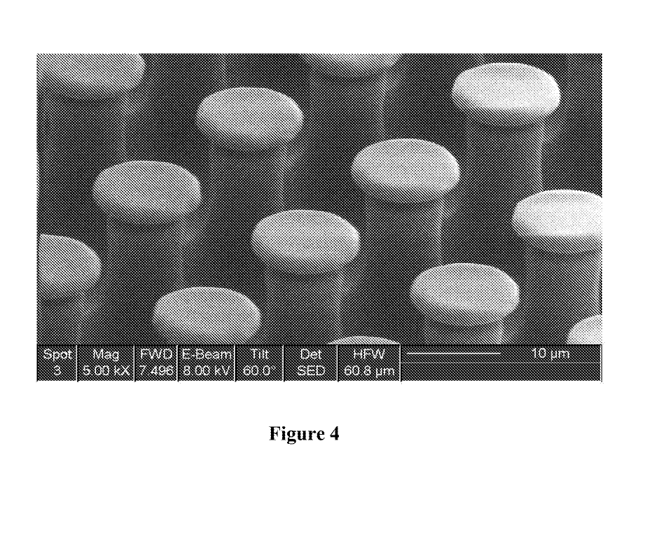

FIG. 5 illustrates a graph of development depth vs. development time for an acrylic mold substrate according to an embodiment of the invention.

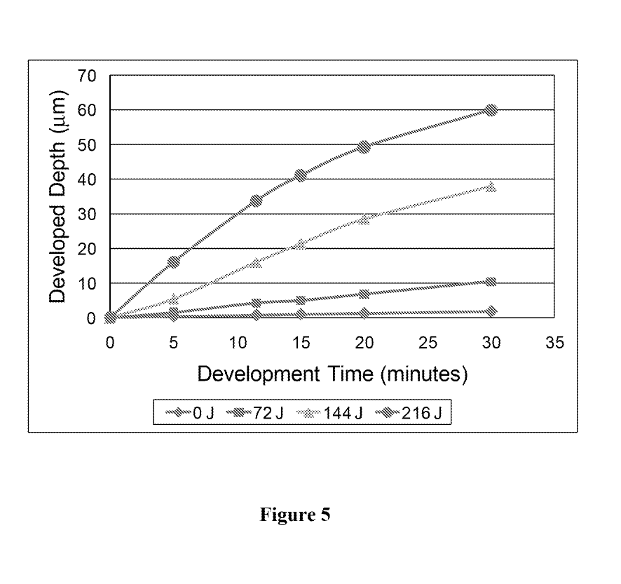

FIG. 6 illustrates a graph of adhesion force vs. preload force for an interlocking dry adhesive structure according to an embodiment of the present invention.

FIGS. 7A-7E illustrate a schematic view of a manufacturing process for manufacturing interlocking dry adhesive structures according to an embodiment of the present invention.

FIG. 8 illustrates optical microscope images of interlocking dry adhesive structure cap tips according to an embodiment of the present invention.

FIG. 9 illustrates graphs of adhesion force vs. preload force for three interlocking dry adhesive structure cap sizes according to embodiments of the present invention.

FIG. 10 illustrates a perspective photographic view of an acrylic master mold substrate according to an embodiment of the present invention.

FIG. 11 illustrates a perspective photographic view of a silicone negative mold according to an embodiment of the present invention.

FIG. 12 illustrates a perspective photographic view of a large composite silicone negative mold structure according to an embodiment of the present invention.

FIG. 13 illustrates an SEM image of an interlocking dry adhesive structure manufactured according to an embodiment of the present invention.

FIG. 14 illustrates an SEM image of a closeup view of the image of FIG. 13 according to an embodiment of the present invention.

FIG. 15 illustrates a schematic view of a partially collimated light source exposure of an acrylic mold substrate according to an embodiment of the present invention.

FIG. 16 illustrates a schematic view of an uncollimated light source exposure of an acrylic mold substrate according to an embodiment of the present invention.

FIG. 17 illustrates a schematic view of an acrylic mold substrate with anisotropic caps according to an embodiment of the present invention.

FIG. 18 illustrates a schematic view of a multi-level hierarchical acrylic mold substrate according to an embodiment of the present invention.

FIG. 19 illustrates a schematic view of an acrylic mold substrate with inclined fibers according to an embodiment of the present invention.

FIG. 20 illustrates a schematic view of an acrylic mold substrate with a thick cap according to an embodiment of the present invention.

FIG. 21 illustrates a schematic view of a partially collimated light source exposure of an acrylic mold substrate through a diffraction grate according to an embodiment of the present invention.

FIG. 22 illustrates a schematic view of a partially collimated light source exposure and development of an acrylic mold substrate according to an embodiment of the present invention.

FIG. 23 illustrates a schematic view of a molding of a silicone negative mold according to an embodiment of the present invention.

FIG. 24 illustrates a schematic view of an uncollimated light source exposure of an acrylic mold substrate with large fibers according to an embodiment of the present invention.

FIG. 25 illustrates a schematic view of a light source exposure of an acrylic mold substrate with directional caps according to an embodiment of the present invention.

FIG. 26 illustrates a schematic view of a multistep light source exposure of an acrylic mold substrate with a multilevel hierarchical fiber structure according to an embodiment of the present invention.

FIG. 27 illustrates a schematic view of a light source exposure of an acrylic mold substrate with inclined fibers according to an embodiment of the present invention.

FIG. 28 illustrates a schematic view of a light source exposure of an acrylic mold substrate with a thick cap according to an embodiment of the present invention.

FIG. 29 illustrates a schematic view of a light source exposure of an acrylic mold substrate with suction cup shaped caps according to an embodiment of the present invention.

FIG. 30 illustrates top and side schematic views of a fiber of an acrylic mold substrate with a directional cap according to an embodiment of the present invention.

FIG. 31 illustrates top and side schematic views of a fiber of an acrylic mold substrate with a cap with divot according to an embodiment of the present invention.

FIG. 32 illustrates top and side schematic views of a fiber of an acrylic mold substrate with a directional trapezoidal cap according to an embodiment of the present invention.

FIG. 33 illustrates a top schematic view of a portion of an acrylic mold substrate with directional hexagonal caps according to an embodiment of the present invention.

FIG. 34 illustrates a schematic view of a parabolic light source exposure of an acrylic mold substrate according to an embodiment of the present invention.

FIG. 35 illustrates schematic views of a parabolic light source reflector according to an embodiment of the present invention.

FIG. 36 illustrates top and side schematic views of a superhydrophobic fiber of an acrylic mold substrate according to an embodiment of the present invention.

FIGS. 37A-E illustrate a schematic view of a manufacturing process for manufacturing anisotropic interlocking dry adhesive structures according to an embodiment of the present invention.

FIGS. 38A-38B illustrate SEM images of interlocking dry adhesive structures with offset caps according to an embodiment of the present invention.

FIG. 39 illustrates an SEM image of an anisotropic interlocking dry adhesive structure according to an embodiment of the present invention.

FIGS. 40A-40B illustrate an optical microscope image and schematic image of an anisotropic interlocking dry adhesive structure according to an embodiment of the present invention.

FIG. 41 illustrates a graph of normalized peeling force vs. peeling angle for an anisotropic interlocking dry adhesive structure according to an embodiment of the present invention.

FIGS. 42A-42C illustrate SEM images of fiber structures of an acrylic mold substrate according to an embodiment of the present invention.

FIGS. 43A-43C illustrate SEM images of interlocking PDMS dry adhesive structures according to an embodiment of the present invention.

FIG. 44 illustrates a schematic view of an exemplary continuous roll compression molding method for producing interlocking microstructures in an extruded polymer film by compression and/or injection molding of the extruded polymer in a flexible mold.

FIGS. 45A-45D illustrate a schematic view of an exemplary compression molding method for producing interlocking microstructures in a heated thermoplastic polymer by compression and/or injection molding of the thermoplastic polymer in a flexible mold.

### DETAILED DESCRIPTION OF SEVERAL EMBODIMENTS

In one embodiment of the present invention, a novel fabrication method is provided that uses deep UV exposures such as from germicidal lamps or other suitable UV sources to convert commercial acrylic substrates (such as polymethylmethacrylate or “PMMA” for example) into master molds for interlocking dry adhesive structures. Such interlocking dry adhesives are inspired by the fibrillar structures found on the feet of geckos and certain spiders, and may desirably provide for multiple overhanging adhesion surfaces (also referred to as “caps”) which may conform and adhere to other surfaces primarily through van der Waals interactions. An advantage of the present fabrication method of such embodiment is in the scale of the patterning that it can achieve, with the capabilities of making repeatable and customizable adhesive structures for a variety of applications and potential mold sizes in excess of those produced in traditional silicon technologies (such as silicon photoresist fabrication), which may typically be limited by the size of the silicon, for example. Such traditional photoresist based fabrication processes have been used to investigate methods of improving yield, adhesion strength, and anisotropic behavior of silicone based dry adhesives. In the present embodiment, the dry adhesive molding technology may be used to scale up to dozens of square feet per individual mold, or may optionally also be appropriate for continuous casting such as by combining multiple molds, or roller molds or other suitable roll-to-roll casting techniques.

The use of 254 nm UV light exposures have previously been made for thin polymethylmethacrylate (PMMA) lithography and MEMS. However, in an embodiment of the present invention, PMMA lithography by UV (such as 254 nm) light exposure may be implemented in a simple method to produce detailed structures on commercial acrylic substrates which may comprise primarily PMMA and additives, and optionally also other suitable known acrylic materials. By using bulk acrylic (such as PMMA) to produce positive molds for subsequent dry adhesive designs, this process of the present embodiment may be used to design a master mold in a relatively stiff material that may be used for optimizing the geometry of subsequently cast dry adhesives.

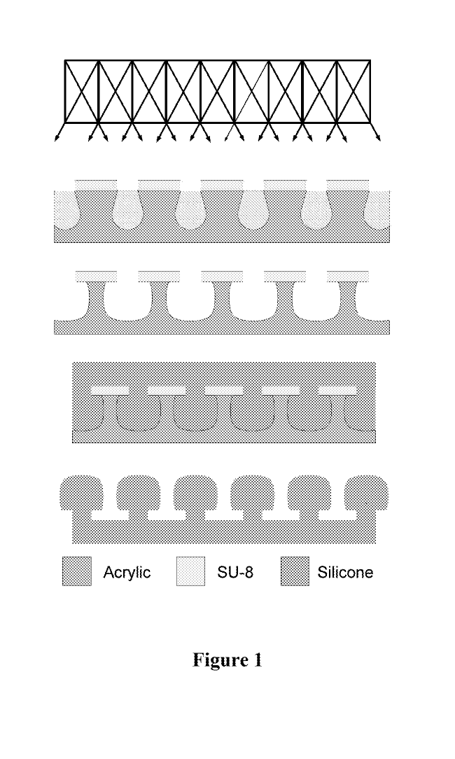

The basic process according to an embodiment of the present invention is outlined in FIG. 1.

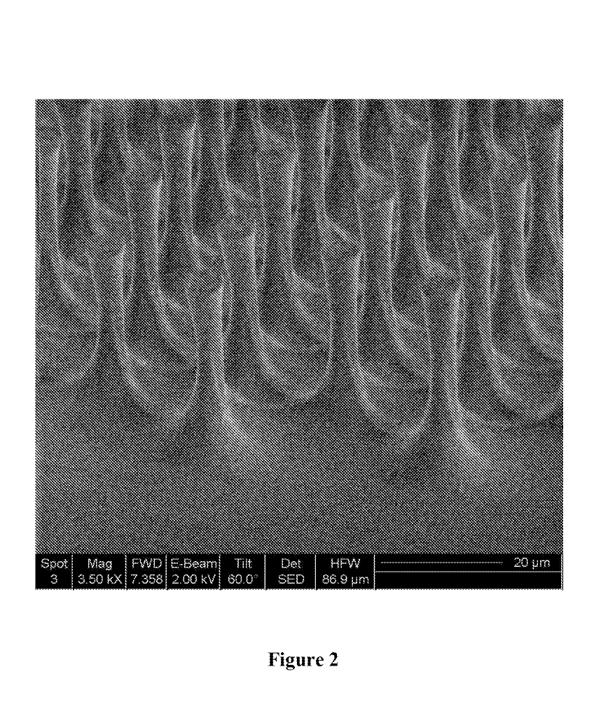

In such method, a thin layer of SU-8 (or optionally another suitable photoresist material) is spun on a commercial acrylic substrate (such as OPTIX® from Plaskolite™), pre-baked, exposed, post-baked and developed. SU-8 is nearly opaque to 254 nm light, and serves as a deep UV mask and as a cap on the top of acrylic fibers. A Stratagene™ 2400 DNA crosslinker or other suitable 254 nm light source may then be used optionally in combination with anti-scatter grids which may desirably have aspect ratios of between about 1:1 and 2:1. Acrylic samples are placed on a rotating turntable during exposure to equalize the UV light dose received through the anti-scatter grids. This system combined with the natural reduction of angle by Snell's Law may desirably produce elongate acrylic fibers, such as fibers with aspect ratios desirably above about 4:1 for example (see FIG. 2) substantially evenly across large areas. In one such embodiment, UV light exposure may be substantially uncollimated.

Optional use of anti-scatter grids in an optional embodiment may desirably reduce the negative sidewall angles and improve the aspect ratio of fibers produced in acrylic. In one embodiment, semi-collimation of large-area 254 nm exposures may be achieved by the introduction of simple anti-scatter grids between the light bulbs and the acrylic substrate. Anti-scatter grids have been extensively used for X-ray collimation purposes where traditional optics are not appropriate, but this method has not previously been widely used in UV lithography due to the relatively severe reduction in exposure intensity. For large-area exposures in certain embodiments of the present invention however, an anti-scatter grid with an aspect ratio as small as 1:1 can produce a much diminished negative sidewall angle with an acceptable increase in exposure time compared to uncollimated exposures. This is partially due to the effect of Snell's law aiding in the reduction in sidewall angle by reducing the light angle as it passes from air to the higher index of refraction acrylic substrate. For higher aspect ratio anti-scatter grids, the further improvement of sidewall angle due to Snell's law is reduced, and the ultimate aspect ratio of features will approach that of the anti-scatter grid. The anti-scatter grids used in embodiments of the present invention may be made of plastic grating commonly found in industrial or commercial lighting over fluorescent bulbs. On exemplary single level grating was approximately 12.5 mm thick, with square holes 12×12 mm in size and ˜1 mm thick walls providing a ˜1:1 aspect ratio grid. Two such gratings may be stacked to form a 2:1 aspect ratio grid. In another optional embodiment, the UV exposure may be at least partially collimated using other suitable collimation means.

In one embodiment, the UV exposure may desirably lower the molecular weight of the acrylic substrate so that it may be removed rapidly in developers, such as known acrylic and/or photoresist developing solutions, for example. In one embodiment of the present inventive method, it has been established that SU-8 developer provides a suitable combination of convenience, speed, and natural undercutting of the SU-8 structures on the surface of the substrate when used to develop the exposed acrylic. Because exemplary acrylic materials such as OPTIX® acrylic material have a relatively low molecular weight, the unexposed acrylic material will preferentially dissolve at a controllable rate which may be controlled by adjusting the temperature of the solvent and particular molecular weight of the acrylic material, to form desirably undercut mushroom shaped acrylic fibers. In one embodiment, the relatively low molecular weight OPTIX® acrylic material may be controlled to preferentially dissolve at approximately 60 nm per minute—forming desirably mushroom shaped acrylic fibers, for example. In another embodiment, the temperature of the solvent may be desirably controlled to adjust the effective preferential dissolution rate of the exposed acrylic, such as to allow for adjustment of the desired undercutting rate during development.

In such embodiment, once the required master shapes (such as the mushroom shaped acrylic fibers and caps) are completed out of acrylic and SU-8 materials, a negative mold may be made of the structure by casting of a suitable silicone-based or other suitable pliable or flexible molding material. After such flexible negative mold, such as a flexible negative silicone mold, is made, multiple materials may be cast from this mold in the shape of the original fiber designs to produce the desired dry adhesive structure. In one embodiment, exemplary such materials which may be cast to form dry adhesive structures include silicones, polyurethanes, siloxanes, polyamides, polyethylenes, or other suitable known castable dry adhesive materials. In an alternative embodiment, such potentially suitable dry adhesive materials may also comprise substantially stiffer and less pliable materials such as substantially rigid or partially flexible polymer materials, for example. In an exemplary embodiment, a Sylgard® 184 polydimethylsiloxane (PDMS) such as is available from Dow Chemical may be used to form the dry adhesive structure. Sylgard® 184 is an exemplary platinum catalyzed silicone material. Preferably, the photoresist materials selected for use in embodiments of the present invention do not significantly inhibit the cure of the Sylgard® 184 or other materials used to produce the dry adhesive structure.

In a further embodiment of the present invention, suitable dry adhesive materials for casting interlocking dry adhesive structures from suitable flexible molds may include, but are not limited to: silicone rubbers (polydimethylsiloxane, polyvinylsiloxane etc.) flexible and semi-flexible polyurethanes, thermoplastic elastomers (including styrenic thermoplastic block copolymers such as styrene-ethylene/butylene-styrene (SEBS) including Kraton G1657 and/or G1645, styrene-butadiene-styrene (SBS), styrene-ethylene/propylene-styrene (SPS), ethylene vinyl acetate (EVA), shape memory thermoplastic polymers, and polyolefin elastomer materials, for example), fluoroelastomers (such as Viton®, Kalrez® etc.), fluorosilicone rubbers, and polysulfide rubbers etc. In a particular exemplary embodiment, suitable dry adhesive materials may comprise a material modulus at small displacements (as an approximation of their hyperelastic behavior) between about 0.5-30 MPa and more particularly between about 1-20 MPa. Optionally, suitable such dry adhesive materials may also comprise a Shore A hardness between about 20 and 100, and more particularly between about 30 and 90. In another optional embodiment, suitable dry adhesive materials may be selected having higher Shore A hardnesses above about 90, for example, where a practical limitation for the hardness of a suitable material may be limited to avoid plastic yielding of the dry adhesive fibers under preload forces, for example. In a particular embodiment, a suitable dry adhesive material may be selected so as to comprise a stiffness material property allowing for both compressing the dry adhesive material without yielding it under relatively large preload forces so that the dry adhesive material makes contact with an opposing surface, while also being stiff enough to provide significant force when loaded in tension without undesirably large displacements. In another particular embodiment, the yield strength properties of a desirable dry adhesive structural material may also be selected to be desirably high enough to withstand anticipated tensile forces experienced with desirably optimized fiber designs without permanent deformations, and a desirably short recovery time in the case of particular viscoelastic structural materials. In a particular embodiment, a suitable castable dry adhesive material may desirably be chemically distinct and have substantially no chemical affinity (such as to avoid chemical or physical bonding) to the flexible mold material.

In yet a further embodiment of the present invention, a method of compression, extrusion and/or injection molding of interlocking dry adhesive structures is provided where a suitable thermoplastic castable dry adhesive material may be molded in a flexible negative mold of the desired interlocking dry adhesive structures, by application of heat and pressure to compress, extrude and/or inject the dry adhesive material into the flexible mold. In one such embodiment, a suitable thermoplastic material, such as a thermoplastic elastomer or other thermoplastic polymer, may desirably be meltable and reformable at a desired temperature range for casting of the interlocking dry adhesive structures in the flexible negative mold, and may desirably comprise a suitable flow rate at a desired processing temperature and also at a desirably low shear rate in order to provide for extrusion, compression molding or injection molding in the flexible negative mold. In another embodiment, the method may comprise extruding a substantially molten film of a suitable thermoplastic material, which may thereafter be cast in a flexible mold such as by injection and/or compression molding under application of heat and pressure. In a particular embodiment, a suitable thermoplastic material may comprise a desirably high melt flow index, wherein higher melt flow index values may typically be preferable to provide for improved casting under low shear rates at a particular desired processing temperature, for example. In a preferred embodiment, the method may desirably provide for casting of the dry adhesive material in the flexible negative mold to produce interlocking dry adhesive structures within a range of processing temperatures such that the dry adhesive material is cast in the flexible negative mold at a casting temperature above a higher glass transition temperature of at least one component of the dry adhesive material, and that the interlocking dry adhesive structures are set within the flexible negative mold at a setting temperature below a lower glass transition temperature of at least one component of the dry adhesive material. In a particular preferred embodiment, the setting of the interlocking dry adhesive structures may also desirably be conducted at a setting temperature or range of temperatures where the flexible negative mold is desirably substantially unstressed, such as to desirably reduce deformation of the final set interlocking dry adhesive fibers. In another preferred embodiment, the flexible negative mold material and dry adhesive materials may desirably be selected such that their thermal shrinkage/expansion rates may be substantially similar over the casting and/or setting temperature ranges of the compression, extrusion and/or injection molding process, such as to desirably reduce shrinkage/expansion stresses in the interlocking dry adhesive structures.

In a particular embodiment of the inventive method comprising compression, extrusion and/or injection molding of thermoplastic elastomer interlocking dry adhesive structures in a negative flexible mold under application of heat and pressure, a non-melting backing layer of a suitable non-melting material may desirably be applied to the thermoplastic elastomer material during the casting process under pressure. In a particular embodiment, the non-melting backing material may also comprise wetting properties with respect to the thermoplastic elastomer dry adhesive material. In one such embodiment, a suitable non-melting backing layer comprising glass, aluminum or other non-melting polymer material such as a Kapton® or other suitable non-melting polyimide film layer, may be desirably applied to the thermoplastic elastomer dry adhesive material during casting under pressure and heat, such as to desirably maintain expansion of the thermoplastic elastomer dry adhesive material in place within the flexible mold during casting and setting, for example.

In one exemplary embodiment, a thermoplastic polymer or elastomer (including styrenic thermoplastic block copolymers such as styrene-ethylene/butylene-styrene (SEBS) including Kraton G1657 and/or G1645, styrene-butadiene-styrene (SBS), styrene-ethylene/propylene-styrene (SPS), ethylene vinyl acetate (EVA), shape memory thermoplastic polymers, and polyolefin elastomer materials, for example) or other suitable thermoplastic polymer material, such as exemplary Kraton G1657 and/or Kraton G1645 styrene-ethylene-butylene-styrene (SEBS) elastomer dry adhesive materials (such as available from Kraton Performance Polymers Inc.) may be used to cast interlocking dry adhesive structures within a flexible negative silicone rubber (such as a TC-5030 silicone rubber from BJB Enterprises) mold. In one such embodiment, the thermoplastic elastomer such as a Kraton G1657 and/or Kraton G1645 styrene-ethylene-butylene-styrene (SEBS) elastomer, may be used at a casting temperature of greater than about 160 C and more preferably about 170 C to about 230 C, and most preferably at a casting temperature of about 200 C, and cast within the flexible negative silicone rubber mold under a suitable casting compression pressure above ambient or atmospheric pressure levels. In a particular such compression molding embodiment, a casting pressure for casting interlocking dry adhesive structures may be applied between suitable plates above and below the thermoplastic dry adhesive material and flexible mold, such as to compress the thermoplastic dry adhesive material into the flexible mold to cast desired interlocking dry adhesive structures. In one such embodiment, at least a bottom one of such plates may be desirably heated to maintain a desired casting temperature, and in an exemplary embodiment, glass surfaces including at least a heated bottom glass plate surface may be used to apply a desired casting pressure. In one embodiment, the thermoplastic dry adhesive material may be premelted, such as by heating and compressing a granular or pellet bulk thermoplastic material to produce a single melted thermoplastic puck or melted thermoplastic mass on a suitable heated surface such as a heated glass plate surface, before compressive molding into the flexible negative mold under a desired compression pressure such as at about 2-5 psi and for approximately one minute, for example. Following compressive molding, the thermoplastic dry adhesive material may be removed from the heated surface and cooled before demolding the flexible mold to reveal the thermoplastic dry adhesive microstructures. In one exemplary such embodiment, Kraton G1657 and/or Kraton G1645 styrene-ethylene-butylene-styrene (SEBS) elastomers may be used to mold thermoplastic dry adhesive structures having any suitable desired dimensions. In a particular embodiment, thermoplastic dry adhesive structures may be molded as mushroom shaped interlocking fibers about 20 um tall, with about 32 um neck diameter, 2.8 um cap thickness with 3.2 um cap overhang, and approximately 10 um gaps between neighbouring caps, for example.

In another particular embodiment, the thermoplastic dry adhesive material may be extruded in a film or elongated mass, and heated plates above and below the thermoplastic adhesive material may be provided in a continuous roll, such as to provide for a substantially continuous casting process. In such an embodiment, suitable interlocking thermoplastic dry adhesive structures may be desirably cast in an exemplary flexible mold using compression molding, with a replication time including setup, casting, cooling and demolding, of about two (2) minutes or less, for example. In another embodiment using an injection molding technique, a thermoplastic dry adhesive material having suitable viscosity properties at a desired casting temperature range may be cast into interlocking dry adhesive structures in a suitable flexible mold, such as to provide a desirably rapid method of injection molding of thermoplastic dry adhesive structures under application of heat and pressure. In other such embodiments, the molding time and/or compressive pressure may be adjusted as desired to provide for suitable flow of the desired molten thermoplastic dry adhesive material into the flexible mold to form the desired dry adhesive structure geometries, and may be varied depending on the type of thermoplastic material and/or geometry of desired dry adhesive structures.

In a particular embodiment directed to producing thermoplastic dry adhesive structures which are suitable for use in applications requiring inhibition of surface contamination on surfaces to which the adhesive structures are removably adhered, such as high purity applications including semiconductor manufacture or clean room material handling dry adhesive applications, a suitable thermoplastic dry adhesive material that inhibits residue or contamination of contacted surfaces may be chosen. In one such embodiment, a Kraton G1657 and/or Kraton G1645 styrene-ethylene-butylene-styrene (SEBS) thermoplastic elastomer may be selected that is desirably adapted to inhibit transfer of oligomers onto surfaces to which the thermoplastic dry adhesives are adhered.

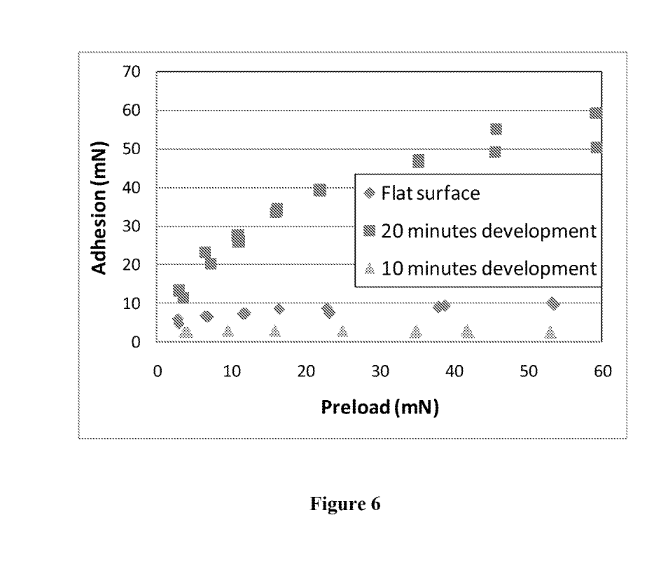

In one embodiment according to the present invention, negative flexible molds, such as silicone rubber molds, may be taken of acrylic master molds for different exposure doses after various stages of development to desirably vary or customize the fiber survival rate, fabrication yield and the effectiveness of interlocking dry adhesives in the resulting geometries (see FIG. 6). Adhesion between SU-8 and acrylic may be strongly influenced by processing conditions and may dominate the lifetime of master acrylic molds. Optimizing process parameters may desirably provide both high yield reusable acrylic master molds and interlocking dry adhesive structures with high adhesive strength. Such optimized embodiments represent a significant improvement in the manufacturability of large areas of microscale interlocking dry adhesive structures and may be advantageously employed as a method to produce high aspect ratio, micro-scale interlocking dry adhesive structures over areas limited in theory only by the size of the acrylic substrate. In another embodiment according to the invention, additional master molds may be produced from desirably durable materials, such as acrylics, polystyrenes, and polyvinylidene fluoride (PVDF) materials, for example, in order to provide for additionally re-usable master molds, such as to allow for inexpensive and rapid casting of interlocking dry adhesive structures.

### Dry Adhesive Structures Adapted to Low Pressure Applications

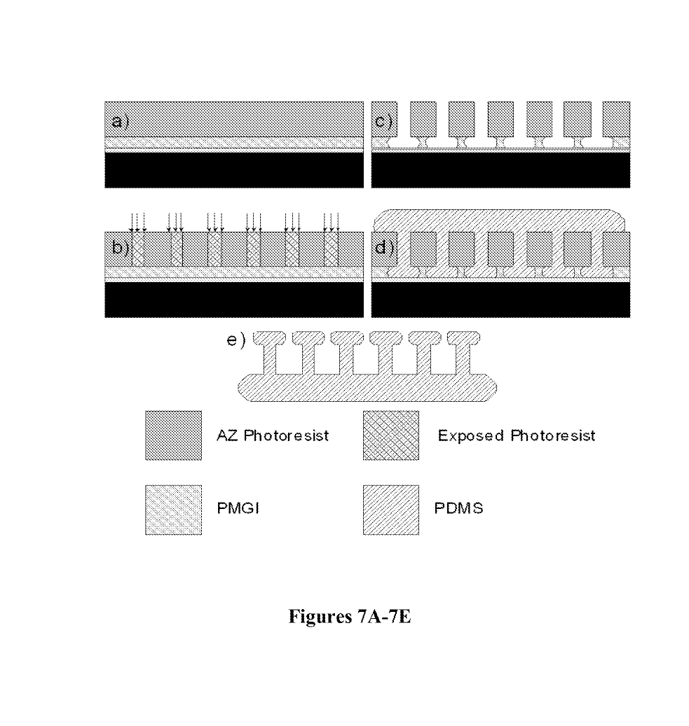

In a further embodiment of the present invention directed to dry adhesive structures for use in low-pressure environments and adapted to evaluate the microscale adhesion capabilities of relatively small radius fibers, a custom interlocking dry adhesive molding system that can be operated within a bell jar to provide adhesion data under a variety of environmental conditions (such as low pressure conditions, for example) was developed. In such embodiment, a polymer molding technology, which is described in further detail below, to produce mushroom shaped fibers of Sylgard® 184 polydimethylsiloxane (PDMS), or other suitable dry adhesive material, and provides an easy method of producing fibers with a large number of potential interlocking geometries. The general process steps are outlined in FIG. 7.

In such an embodiment as illustrated in FIG. 7, a gold-coated silicon wafer may be used as a base because the PDMS material may typically not adhere to the gold, and a surface modification step may be avoided. Then, a deep UV sensitive photoresist, such as polymethylglutarimide (PMGI), is applied to the wafer to be used as an undercutting layer, such as by being spun onto the wafer. This photoresist material may preferably have good adhesion to gold, may desirably promote adhesion of subsequent spin-on layers, and exposure to 254 nm UV light may desirably increase its dissolution rate in a suitable photoresist developer, such as a developer solution, for example. In one embodiment, a final layer of AZ 9260 photoresist may be applied, which is desirably positive acting and may be patterned in thicknesses up to 100 μm, for example. This final layer photoresist may desirably work well because the positive sloping sidewalls may improve demolding yield and a dry adhesive material, such as PDMS may be easily released from this material without requiring a silanization step.

In such an embodiment, a single wafer may be used to mold the dry adhesives, and the cap size of the interlocking dry adhesive structure may be altered by exposing the PMGI through a shadow mask to several doses of 254 nm UV light prior to application of AZ 9260 material such as by spin coating. This may desirably allow different fiber geometries to be produced using one mold under identical processing conditions. After the molds are completed, PDMS or another suitable dry adhesive material may be prepared (such as PCMS mixed up at a ratio of 10:1 pre-polymer to catalyst), optionally degassed under light vacuum and applied to the wafer, such as by being spun onto the wafer to get an even film. The wafer may then be degassed again such as for 1 hour before curing such as at 50° C. for 16 hours, for example. The dry adhesive structures may then be demolded, and baked such as for 1 hour at 120° C. to improve their strength, and stabilize the cure. In other embodiments, compression, extrusion and/or injection molding techniques may be used to cast suitable thermoplastic dry adhesive materials into flexible negative molds under application of heat and pressure, to produce interlocking dry adhesive structures.

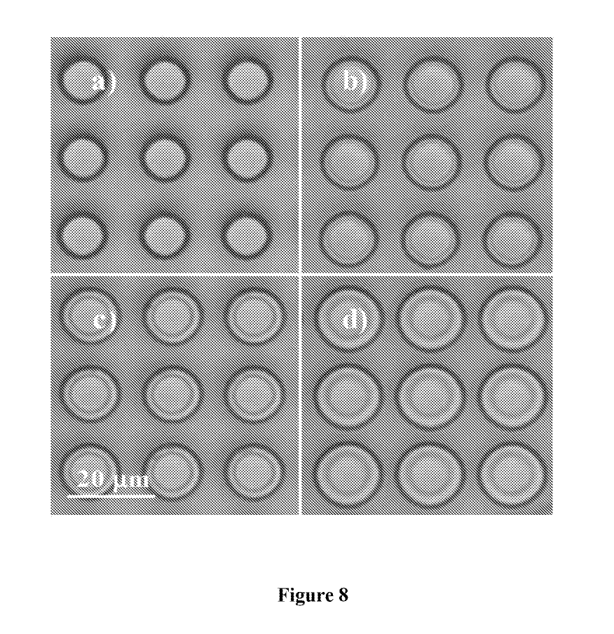

FIG. 8 shows optical images of four cap sizes of dry adhesive structures which were manufactured according to the method illustrated in FIG. 7, according to an exemplary embodiment of the present invention. The average cap diameters were measured with an eyepiece micrometer and are considered accurate to ±0.2 μm based on multiple measurements across each sample. The posts or fibers of the dry adhesive structure were defined with approximately 10 μm diameter pillars with a center-to-center spacing of approximately 20 μm in a square array. Each post was approximately 20 μm tall including the cap thickness of approximately 1.5 μm.

Adhesion forces of dry adhesive structures produced according to the embodiments described above in reference to FIGS. 7 and 8 were measured using a custom test system consisting of a sensitive load cell (Transducer Techniques GSO-25), connected to a vacuum compatible linear stage (Zaber Technologies T-LS28-M) that was controlled using custom software written in LabView 8.2. The load cell was connected to a 6 mm diameter sapphire hemisphere lens (Edmund Optics, NT49-556), which would contact the adhesive and minimize the effect of misalignments. Pull off speeds were limited to 5 μm/s and the force sensor was moved in displacement control with multiple tests at each indentation depth. The load cell, linear stage, and adhesive were all fixed to a steel plate that formed the base of a Nalgene® bell jar vacuum chamber that could be pumped down to ˜10 kPa pressure.

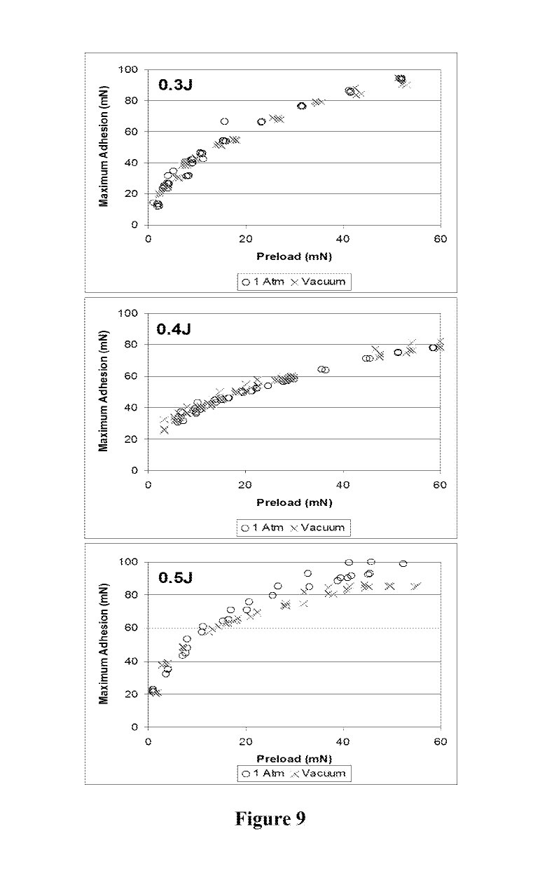

A series of adhesion tests were performed at atmospheric conditions, with varying preloads to test the base adhesive response of the dry adhesive structures. Tests on a flat PDMS surface at different pressures displayed no apparent change in adhesion vs. preload, despite the relative humidity dropping within the chamber under vacuum, suggesting that the adhesion performance of dry adhesive structures according to the present embodiments are insensitive to the effects of relative humidity. Displacement control of the linear stage was used to provide an increasing series of preloads, and the maximum adhesion was measured for each point. The dry adhesive structure sample with the smallest caps was found to have very little adhesion relative to the caps defined using 0.3J exposure dose, and was excluded from further analysis. Dry adhesive samples were first preloaded with large forces multiple times before adhesion data was collected. Typically, the adhesion strength of dry adhesives has been found to diminish with time, as surface contamination or fiber collapse becomes significant. In the dry adhesive samples according to the above embodiments, the equilibrium adhesion strength after multiple load cycles was considered a better representation of the long-term performance of these dry adhesives, and was therefore included with these measurements. For all dry adhesive structure fibers with the exception of those defined with the 0.5J exposure dose, fibers remained uncollapsed after large preloads. The resulting curves of preload vs. adhesion strength are shown in FIG. 9. The low pressure or vacuum trials were completed with a −90 kPa gauge pressure.

Upon testing of the above-described dry adhesive structure embodiments, there was desirably no discernable effect of lower atmospheric pressures on the adhesion strength of mushroom shaped dry adhesive fibers at different preloads, and the general reduction of adhesion strength with repeated contact/pull-off cycles was a far larger component of the variation in adhesive strength observed. While a small difference in adhesion is observed for the fibers with the largest caps, this effect appeared most likely due to increased fiber collapse, and this sample had the highest variation in adhesion performance under both atmospheric and low pressure testing.

According to one embodiment of the invention, a variety of different fiber geometries with mushroom cap dry adhesive structures (such as described above in reference to FIGS. 7 and 8) were produced and tested to determine if there is any significant pressure sensitivity with adhesive structure caps greater than about 16 μm in diameter supported by approximately 10 μm diameter pillars. The polymer molding technology described above in reference to FIG. 7 was found to provide control over the physical dimensions of PDMS fibers and mushroom shaped fibers with caps diameters over 50% larger than that of the supporting pillar that have been successfully demolded to test for pressure sensitivity in the present embodiment. Despite the large cap to fiber size ratio of the dry adhesive structures produced and tested in the present embodiment, desirably no significant pressure sensitivity could be determined for these dry adhesive structures, indicating that these elastomer based dry adhesives primarily rely on van der Waals attractive forces as other potential attractive forces such as due to capillary forces, humidity related effects, and atmospheric pressure effects appear to be negligible in the adhesive performance of the present elastomer based dry adhesive embodiments. Therefore, the present elastomer based dry adhesive embodiments may also be suitable for applications involving low-pressure or substantial vacuum environments, such as for space applications, for example.

### Further Dry Adhesive Structure and Production Method Embodiments

In the embodiments of the present invention directed to production of dry adhesive structures, SU-8 may be used as a suitable and useful cap producing material and photoresist in the production method, such as described above. However, in other embodiments, other materials such as photoresists, metals, UV insensitive polymers and others suitable materials may alternatively be employed. In one such embodiment, a commercially available mirrored acrylic (PMMA with aluminum already deposited on it) may be used, which may allow the production of interlocking dry adhesive structures having multiple levels of fibers through different UV light exposures, doses and patterns, without requiring an SU-8 layer to form the cap material, for example. In another embodiment, a non-photosensitive material may be stamped, embossed or deposited in a desired pattern to provide the cap material for the desired interlocking dry adhesive microstructures without requiring an SU-8 or other photosensitive material.

Additional advantages of the flexible molding process described above in reference to FIG. 1 may desirably include:

In further embodiments of the invention, substantially any suitable material that may be cast (either as polymer precursors, dissolved in a solvent or melted, such as in the case of thermoplastics and thermoplastic elastomers) may be formed as an interlocking dry adhesive structure according to an embodiment of the invention, such as by using the molding dry adhesive production methods described above and illustrated in FIG. 1, and/or the above-described compression, extrusion and injection molding production methods using application of heat and pressure to mold thermoplastic interlocking dry adhesive structures, for example.

In a further embodiment, interlocking dry adhesive structure caps may be defined into almost any desired shape, thickness, or size such as through control and variation of one or more of the photoresist mask design or pattern, pre-exposure, exposure and development process steps, and UV light exposure dose. In an exemplary embodiment, the fiber and cap geometries may be configured with fiber heights such as from about 1 um to 100s of um, fiber aspect ratios from less than about 1:1, to more than about 5:1, and cap shapes and/or fiber cross-sections such as substantially round, oval, hexagonal, or rectangular, for example. Such configurability of the interlocking dry adhesive structure caps and/or fibers may desirably allow tailored adhesion strength properties across a single sheet of dry adhesive. In a further embodiment, such configurability of the caps may desirably provide for anisotropic adhesion behavior when desired, such as disclosed in further detail below. In yet a further embodiment, such configurability of the interlocking dry adhesive structure caps may desirably provide the ability to define the optimal interlocking dry adhesive fiber geometry for nearly any dry adhesive structural material or expected adhesion application or environment.

In another embodiment, interlocking dry adhesive structure fibers may be naturally formed with fillets on the base of the fibers, such as due to the diffraction angles and properties of the UV light source used to expose the dry adhesive mold substrate. In such an embodiment, the filleted shape of the base of the dry adhesive fibers may desirably provide increased survivability of the fibers during demolding of the interlocking dry adhesive structure (removal of the dry adhesive structure from the mold) because there are few stress concentrators, and the smooth surfaces allow easy dry adhesive material removal with desirably less likelihood of damage or loss of interlocking dry adhesive fibers, and may desirably also provide for improved filling of the mold during compression/injection molding of the dry adhesive material in the flexible mold, for example.

In a further embodiment, the interlocking dry adhesive fibers may optionally be defined with any one of collimated, partially or semi-collimated, or substantially uncollimated UV light sources, or combinations thereof. Such UV light sources may comprise light at 254 nm and lower wavelengths, for example. While in some embodiments the specific wavelength of UV light exposure may not be critical, a 254 nm light source may be the easiest to produce for exposure on large scales. In such embodiments, the exact shape of the interlocking dry adhesive fibers may be controlled by one or more of the light exposure dose, PMMA molecular weight, solvent used for the PMMA development and the total development time, for example.

In yet a further embodiment, PMMA molds may be produced in any size suitable for the process steps required for producing the interlocking dry adhesive. In a particular embodiment, PMMA mold sizes may be several dozen square feet, or may alternatively be quite small depending on the resources available to make the original master mold. In one embodiment, the PMMA master molds may comprise either a single or multiple level mold hierarchy, such as may be provided by using a single or multiple layers of photoresist or other suitable material for masking/forming the cap and/or fiber features of the interlocking dry adhesive structure. Such flexibility of using single or multiple level master mold hierarchies may desirably provide for direct casting of repeatable single or multiple hierarchal interlocking dry adhesive structures according to the invention.

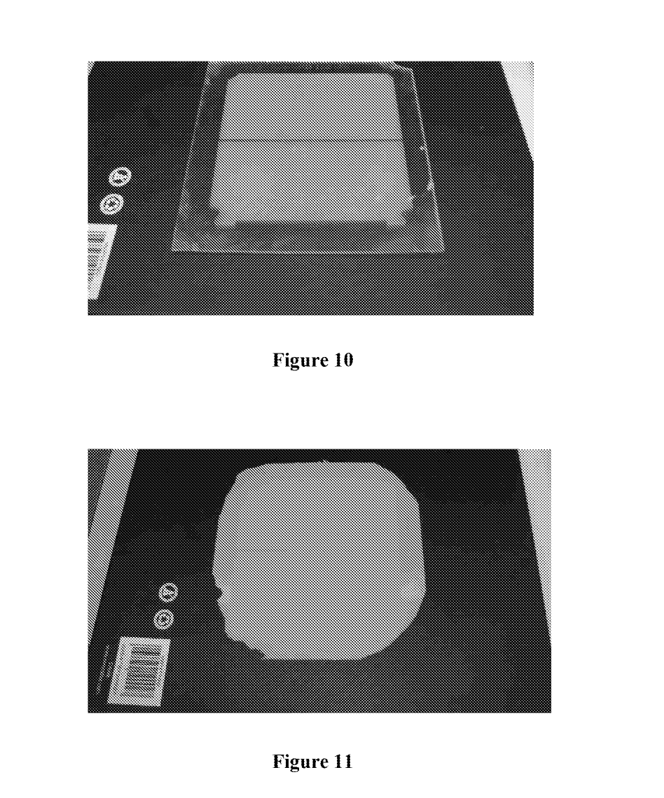

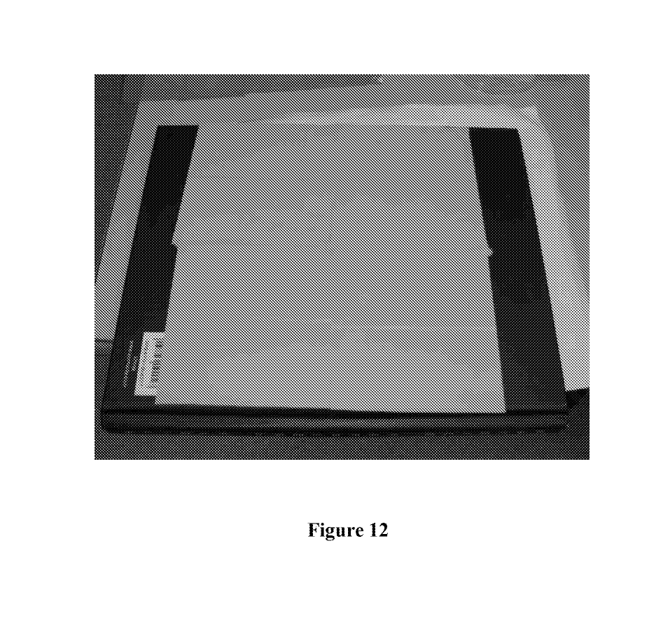

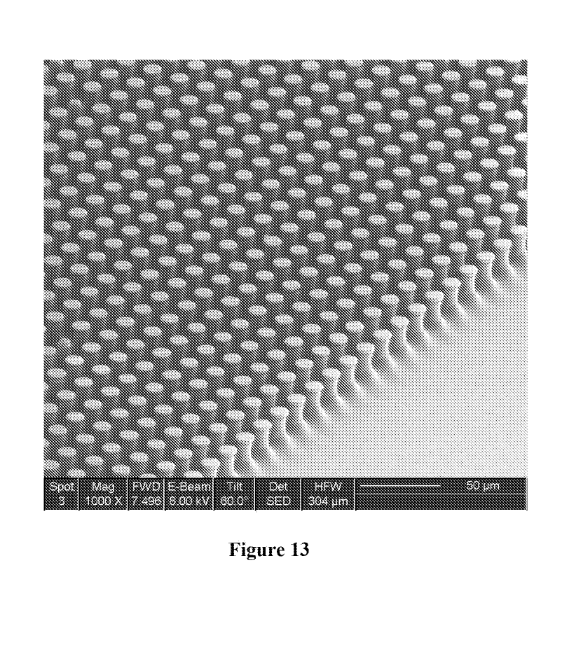

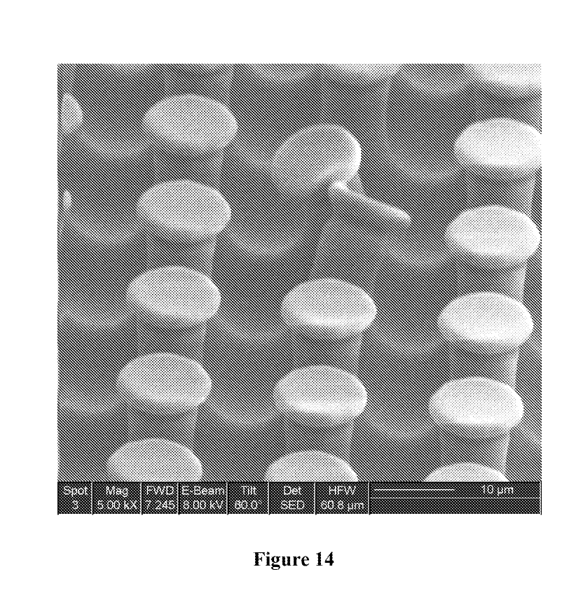

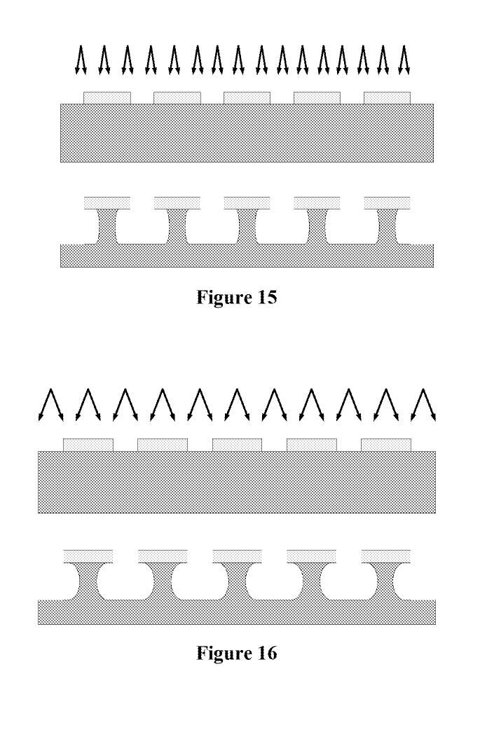

In one embodiment, silicone or other suitable flexible molds may be created from the acrylic master molds desirably without requiring any prior surface treatments to the acrylic master molds. In such an embodiment, the flexible molds may desirably be tough and sufficiently flexible, allowing even substantially rigid interlocking dry adhesive structural materials to be demolded successfully. In another such embodiment, once an original acrylic master mold is created, it may be duplicated in a suitable substantially rigid material, such as an exemplary hard polyurethane, polystyrene, PVDF, or other plastic material, to enable the making of sister molds as may be desirable for faster duplication of dry adhesive structures, and/or to provide backup molds. In yet another such embodiment, the casting of a hard plastic or other substantially rigid material using the silicone or other flexible mold and curing or setting the small interlocking dry adhesive fiber structures on other surfaces may desirably allow the assembly of complex hierarchal interlocking dry adhesive structures that may be otherwise impossible using existing fabrication techniques. In one embodiment as described above, very large master molds may be made as a singular mold component, or alternatively, smaller versions of a master mold (such as <1′×1′ for example) may be made, as illustrated in FIGS. 10 and 11. Subsequently, such smaller master mold components may optionally be assembled make a larger elastomer mold out of several smaller molds as illustrated in FIG. 12 for example. SEM images of exemplary elastomeric interlocking dry adhesive structure fibers and caps produced from the negative silicone molds of FIGS. 10-12 are shown in FIGS. 13 and 14.

In an alternative embodiment, surface treating either the acrylic master mold or subsequent elastomer or other flexible (such as silicone for example) negative molds may provide for producing dry adhesive structures out of any suitable castable materials, including for example, epoxies, silicones, polyurethanes, natural and artificial rubbers polyimides, silicone rubbers (polydimethylsiloxane, polyvinylsiloxane, etc.), flexible and semi-flexible polyurethanes, polystyrenes, thermoplastic elastomers (including styrenic thermoplastic block copolymers such as styrene-ethylene/butylene-styrene (SEBS) including Kraton G1657 and/or G1645, styrene-butadiene-styrene (SBS), styrene-ethylene/propylene-styrene (SPS), ethylene vinyl acetate (EVA), shape memory thermoplastic polymers, and polyolefin elastomer materials, for example), fluoroelastomers (Viton®, Kalrez® etc.), fluorosilicone rubbers and polysulfide rubbers, for example. In a particular embodiment, a suitable castable dry adhesive structural material may desirably provide for producing substantially smooth and substantially void free surfaces that faithfully replicate the relative geometries of the interlocking microstructures of the flexible negative mold.

In one embodiment, exemplary final interlocking dry adhesive structures may be desirably formed from suitable dry adhesive materials which have substantially low surface energy, are substantially solvent tolerant and have Young's modulus values between ˜1 MPa-1 GPa. Further, certain desirable dry adhesive structural materials may also exhibit accelerated cure rates through the application of heat, radiation or other means, or rapid unaccelerated cure times of about a few minutes or less. In one exemplary embodiment, silicone rubbers without fillers (particles of silica etc.) may be used for interlocking dry adhesive structures intended for long-term use. In another embodiment, materials used for preparing negative molds for casting the interlocking dry adhesives may comprise addition cured silicones which may be surface treated with silanes for subsequent silicone molding, or left untreated for casting other non-silicone materials. In an alternative embodiment however, other suitable materials may be used to form the negative molds, which may desirably be pliable and easily released, and may further desirably be softer than the final interlocking dry adhesive material for best demolding results. In another embodiment, thermoplastic elastomers or other thermoplastic polymers may be used for casting interlocking dry adhesive structures in flexible negative molds using compression, extrusion or injection molding techniques which may exhibit desirably rapid thermo-molding and setting times of less than two (2) minutes, preferably less than about one (1) minute, and more preferably less than about thirty (30) seconds, for example.

In a further embodiment, a particular interlocking dry adhesive structure fiber shape may be created in PMMA for any dry adhesive materials with a Young's modulus lower than that of the PMMA. In such an embodiment, the fiber shape may thereby depend on the dry adhesive material stiffness, viscoelasticity, and strength, in addition to the fabrication limits (such as surface roughness for example) when making the original master mold. In one embodiment, larger interlocking dry adhesive fibers with diameters greater than about 30 μm may be easily defined without requiring a collimated light source, due to the undercutting limits of PMMA. In another embodiment providing smaller fibers, a more collimated light source may be used to undercut into the fibers under the caps before the PMMA fiber falls off the substrate. In general, the most effective fiber size, spacing and cap dimensions may depend on the dry adhesive structural material chosen. In a further embodiment, the UV light source does not have to be 254 nm, and for example, a 184 nm light could also be used from the same light bulbs, which may provide a much faster exposure for small features but may require that the exposure be completed in a vacuum or under inert atmosphere (no O2), rather than the less stringent atmosphere requirements of the 254 nm light source.

In embodiments utilizing an SU-8 layer such as illustrated in FIG. 1, the SU-8 caps may be patterned using a suitable patterning/printing process such as soft lithography or nano-imprint lithography prior to initial PMMA exposure to define even smaller fibers/caps or other features, for example. In one embodiment, a high quality nanoscale mold in silicone for instance may be used to cure SU-8 in much smaller interlocking structures than can be accurately defined in normal lithography. In a further embodiment, additional levels may be added to interlocking dry adhesive structures such as by gluing multiple elastomer molds together. However, in such an embodiment, larger interlocking structures may typically take longer to fill in or cast, and vacuum and/or greater heat or pressure may required to fill in fibers or other features greater than a few hundred μm in size.

In an embodiment of the present invention wherein fiber and cap sizes are in the range of about 1-200 um in size, the application of uncured elastomeric dry adhesive structural materials to a flexible negative mold to cast the interlocking dry adhesive structure may desirably be made without the application of vacuum. In such embodiments, the uncured dry adhesive structural material (such as PDMS, polyurethane, polyimide, for example) may be applied to the mold using a spreading technique, such as by using a spreading utensil to force the material into the mold, and/or optionally by also applying a kneading motion to the flexible mold to fill in the fibers/caps and other features of the interlocking dry adhesive structure. In one embodiment, such spreading and kneading techniques may be enabled by the unique shape of the interlocking dry adhesive fiber features such as the flared or filleted bottom of the fibers, and/or by the flexibility of the negative mold material. Such embodiments may desirably avoid the use of vacuum during casting, which may improve the speed, economics and simplicity of the dry adhesive manufacturing method as described above and in reference to FIG. 1. In a further embodiment, an interlocking dry adhesive fabrication method may be provided that uses one or more of physical agitation, electrostatic charge, mechanical scraping and applied pressure and/or heat to a mold to assist in filling in the mold with castable dry adhesive material for fabrication of the interlocking dry adhesive structures. In a particular embodiment using thermoplastic dry adhesive materials, pressure and heat may be applied for compression, extrusion or injection molding of thermoplastic materials, such as thermoplastic polymers and thermoplastic elastomers, into flexible negative molds to produce the desired interlocking dry adhesive structures, which may then be cooled and demolded.

In particular embodiments of the present invention, one or more anti-scatter grids may be used between the UV light source and the acrylic mold substrate during exposure. In such embodiments, the anti-scatter grid may act to removes a substantial portion of the light from the light source and thereby to substantially lengthens the exposure time for producing the master acrylic mold. In further embodiments, one or more other mechanisms or techniques for providing collimation of the UV light source during exposure may also be used. Exemplary such exposure control light sources may comprise UV light emitting diodes, UV lasers with beam expanders and compact UV bulbs with parabolic reflectors for example. In a further embodiment, a lens, such as a hot embossed, cured or fresnel lens may be placed between the acrylic mold substrate and the UV light source during exposure, such as to produce angled lithographic patterns due to the refraction effects of the lens on the UV light source, for example.

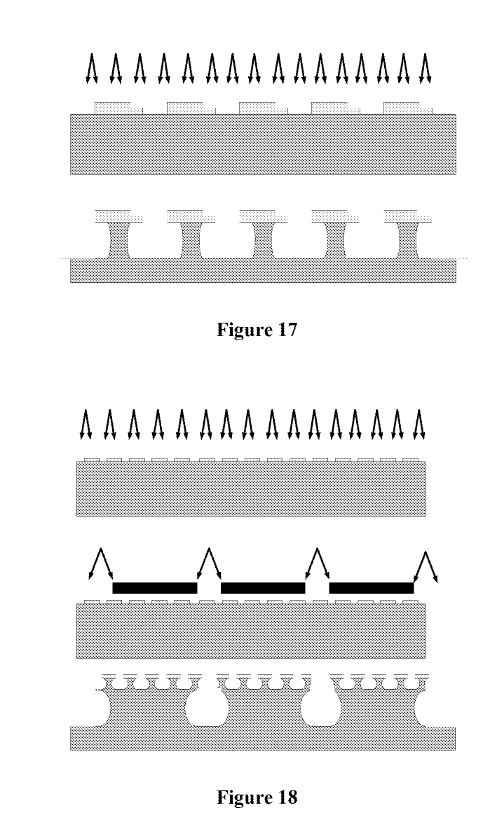

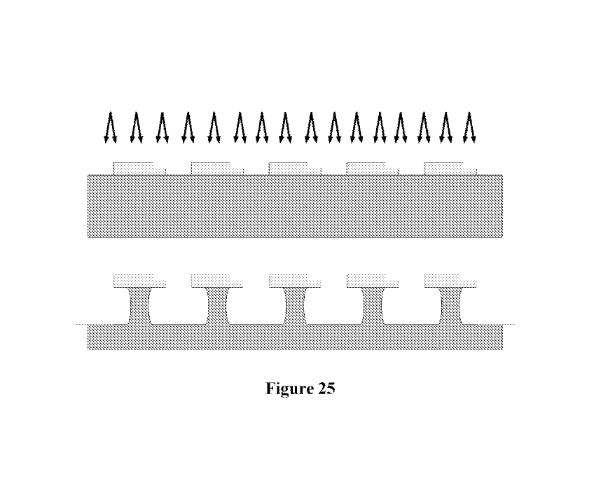

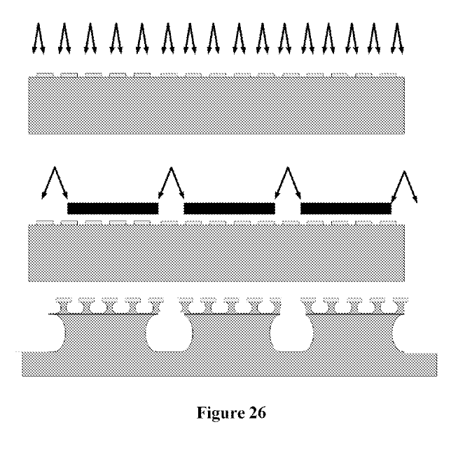

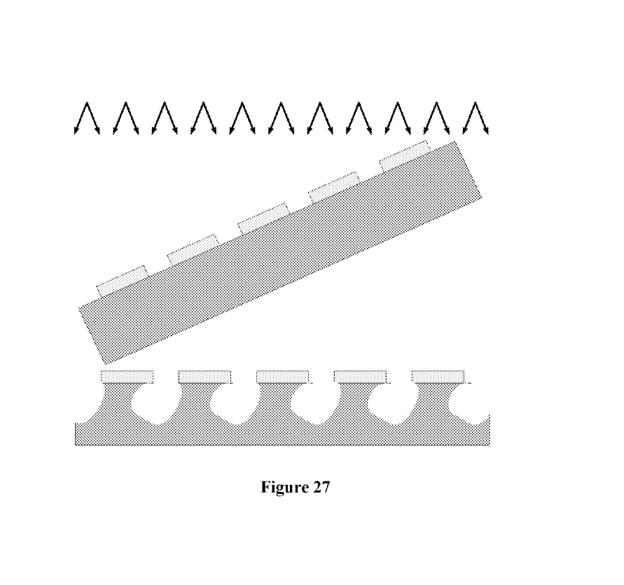

In a further embodiment, a partially collimated exposure and/or light source may be used for producing molds comprising features such as relatively higher aspect ratio interlocking fibers, or alternatively to provide a more even and/or slower development rate of the mold substrate material, as illustrated in FIG. 15, in which the yellow features represent SU-8 material which forms interlocking caps, and blue features represent the mold substrate such as PMMA which forms the fibers or post features of the mold structure. A partially collimated light source exposure in a similar embodiment is also shown in FIG. 21, which further illustrates the exposed PMMA material margins between the posts and undercutting the SU-8 caps. FIGS. 22 and 23 respectively illustrate a partially collimated light source exposure of higher aspect ratio fibers in the PMMA substrate, and the production of a reverse mold of the interlocking structure in a flexible mold material, such as silicone for example, according to an embodiment of the present invention. Such silicone or other flexible reverse mold as illustrated in FIG. 23 may then be used to cast an interlocking dry adhesive structure comprising the desired fiber (post) and interlocking cap features produced in the PMMA/SU-8 master mold according to an embodiment of the invention.

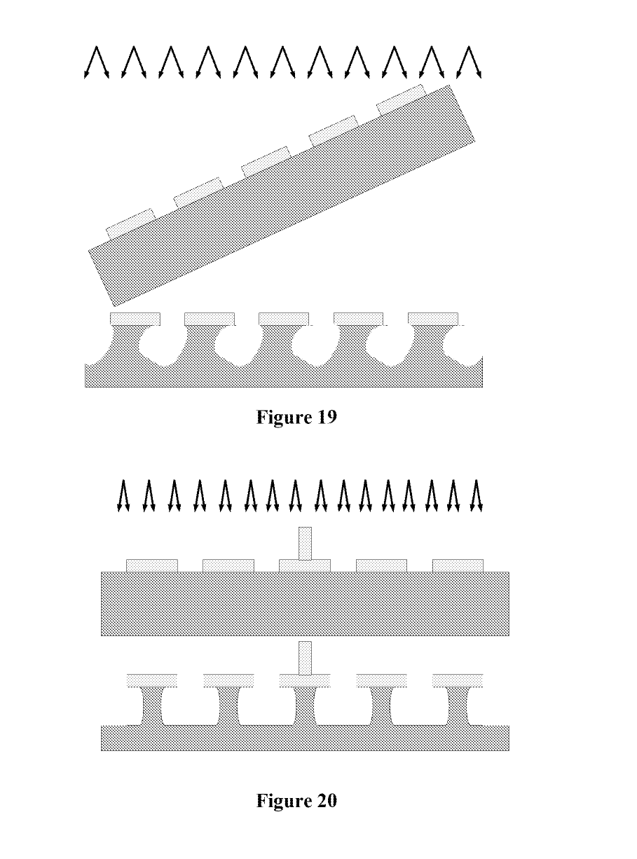

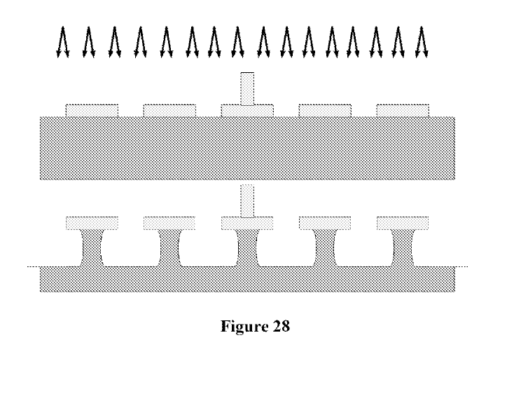

In another embodiment, a substantially uncollimated UV light source may be used to expose substantially low aspect ratio fiber features in the PMMA substrate, as illustrated in FIGS. 16 and 24, for example. In such embodiment, the uncollimated light exposure produces fibers with low aspect ratios of about 1:1 width to height under exposure, before the pillar may be undercut and the resulting fiber falling off during development. However, for embodiments where the PMMA substrate comprises substantially larger dimension fibers or posts such as about >20-30 um in diameter, such uncollimated exposure may comprise the easiest and fastest method of manufacturing. Such resulting interlocking dry adhesive structures may be desirably adapted for adhesion to relatively flat surfaces, for example. In another aspect, a substantially uncollimated UV light source may be used to expose any suitable and desired aspect ratio of fiber features in a PMMA or other suitable substrate, such that patterning of the desired fiber structures may be adapted to suit any desired interlocking fiber and/or cap geometry.

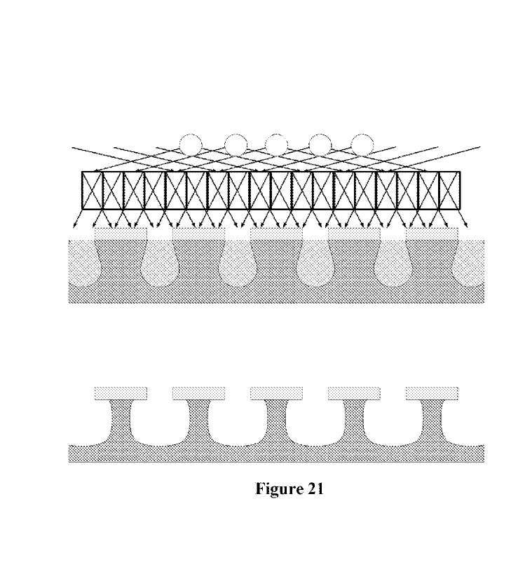

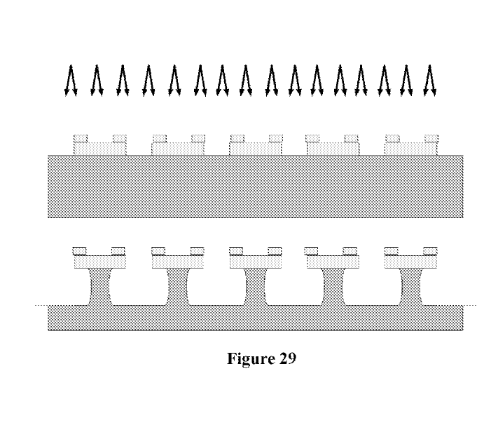

In a further embodiment, SU-8 caps on the PMMA material may comprise two levels, or may have a small cavity in their upper surface, such as to produce a small defect in the same part of each cap on the fibers of the PMMA substrate after exposure and developing, as shown in FIGS. 17 and 25, for example. Such intentional cap defects may provide for fibers of the resulting interlocking dry adhesive structure that are vulnerable to peeling or losing adhesion in one direction, providing an anisotropic dry adhesive.

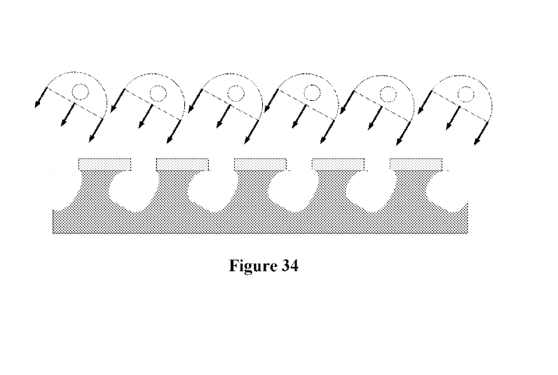

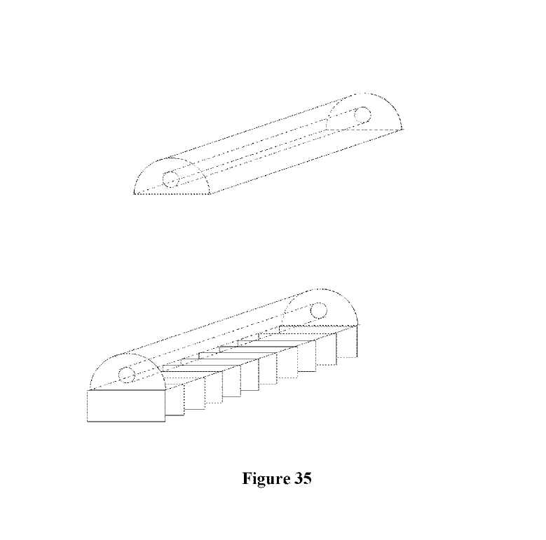

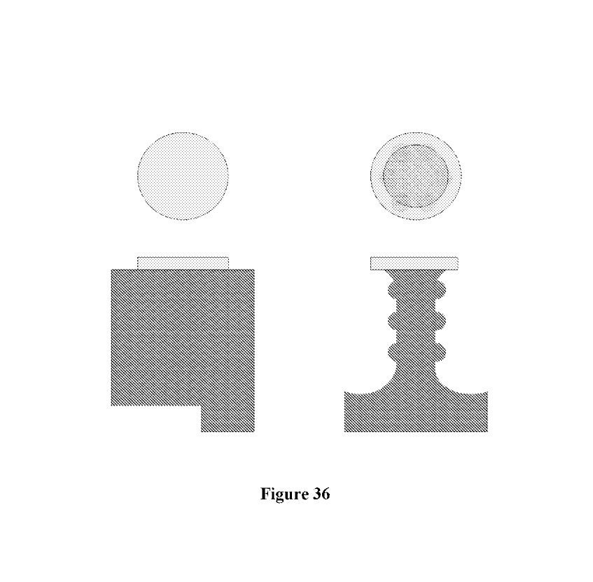

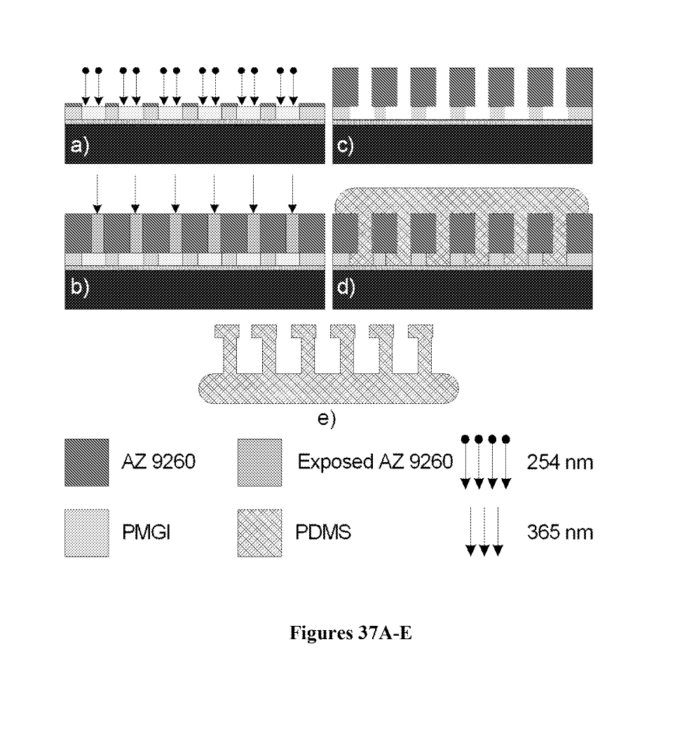

In another embodiment, a directional or anisotropic interlocking dry adhesive may be provided by providing single level SU-8 caps which comprise a linear gap across a portion of the cap, as illustrated in FIG. 30, for example, such that upon development of the PMMA mold, a consistent portion of the caps will fall off or will tear or otherwise fail during demolding, leaving an intentional truncated cap defect which results in a dry adhesive fiber prone to peeling in one direction. A further directional or anisotropic embodiment comprises providing single level SU-8 caps with a divot missing, to provide an intentional cap defect and result in a desired dry adhesive anisotropic peel characteristic, as illustrated in FIG. 31, for example. Yet a further directional or anisotropic embodiment comprises providing single level SU-8 caps with a trapezoidal cross-section, to provide an intentional cap defect and result in a desired dry adhesive anisotropic peel characteristic, as illustrated in FIG. 32, for example. Another directional or anisotropic embodiment comprises providing hexagonal shaped SU-8 caps with a linear cap defect, which may result in a desired dry adhesive anisotropic peel characteristic, as illustrated in FIG. 33, for example. Further such embodiments may comprise intentional cap defects in a single direction such as a shifted cap which overhangs only on one side of the fiber, or overhangs less on one side than the others, which may provide a consistent cap defect or lack of overhang resulting in a desired dry adhesive anisotropic peel characteristic.

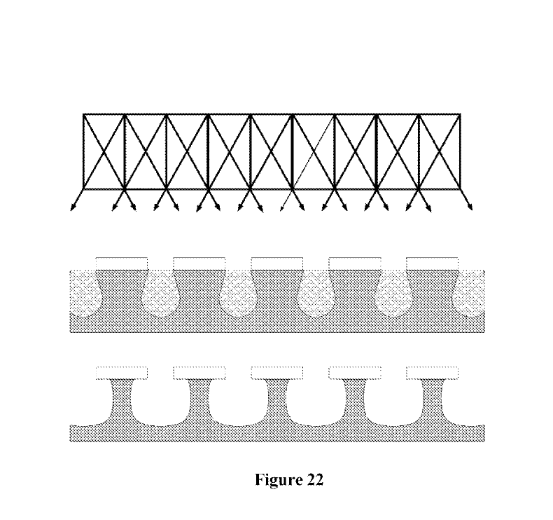

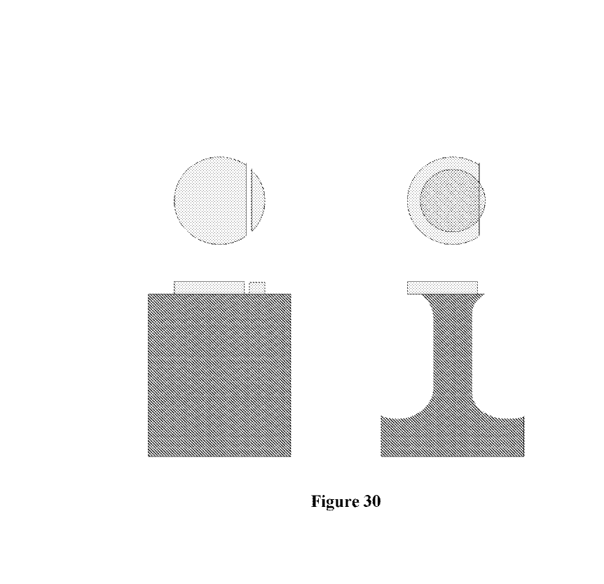

In yet a further embodiment, a multi-level hierarchy may be provided in a PMMA substrate mold, to produce a resulting multi-level interlocking dry adhesive. A partially collimated UV light exposure may be used to define the small fibers in the upper level of the hierarchy, while a longer, uncollimated light exposure may be used to produce bigger pillars such as in the lower level of the hierarchy, as shown in FIGS. 18 and 26, for example. In such an embodiment, the mask used for the larger pillars in the lower hierarchy comprise any suitable material, such as a photoresist material, metal, or something as simple as dry erase marker ink directly on the PMMA/SU-8 material (water soluble ink may be preferable for easy removal), for example.

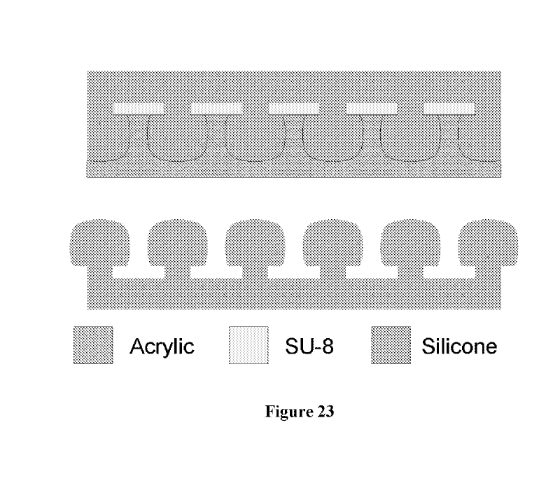

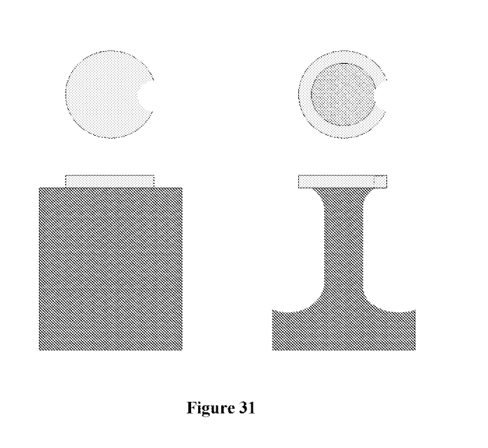

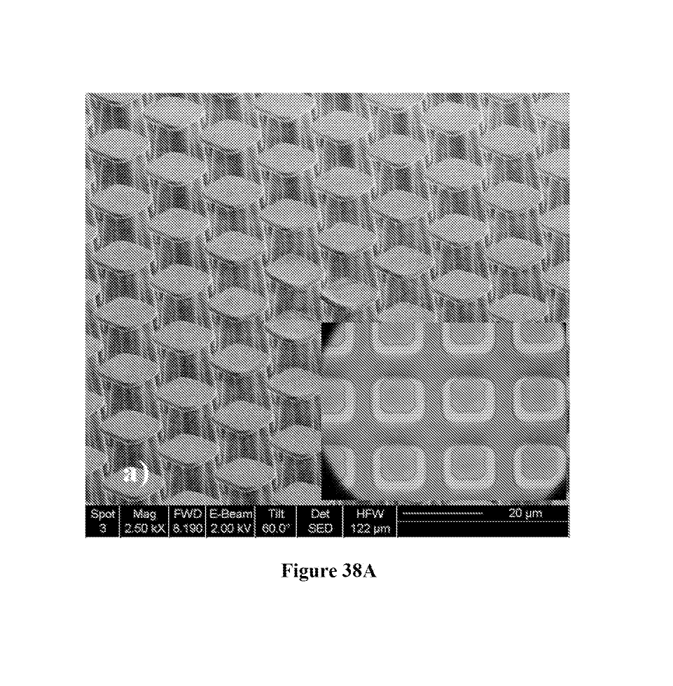

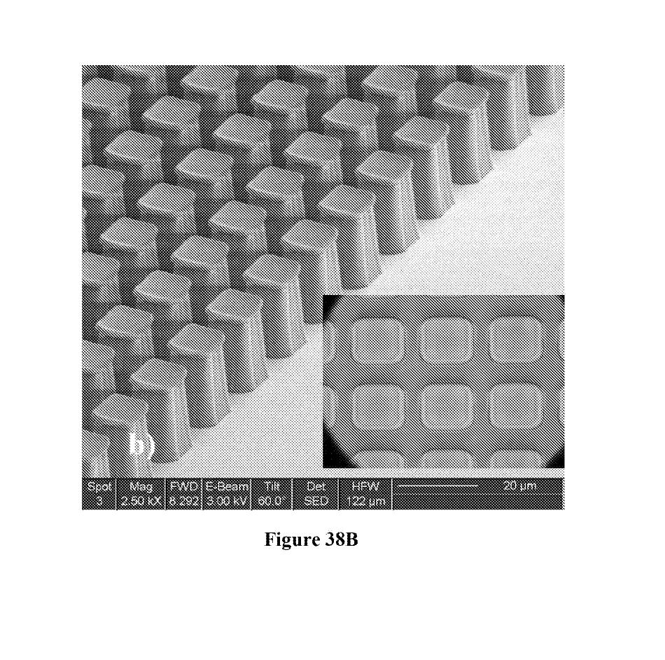

In another embodiment of the invention, an inclined exposure of UV light may be applied to the PMMA/SU-8 mold substrate such as by inclining the mold substrate with respect to the UV light source during exposure, as illustrated in FIGS. 19 and 27, for example. Such exposure may include collimated, partially collimated and/or un-collimated UV light, as may be desired. Such inclined exposure may desirably provide a feature where the cap is slightly offset relative to the center of its supporting fiber, as shown in FIGS. 19 and 27. Such arrangement of the inclined fiber may be desirable for relatively stiffer dry adhesive materials as the inclined fiber may provide greater flexibility to allow better conformance of the cap to a surface such as to provide improved adhesion, for example. In a further embodiment, an inclined exposure of light may be applied to the mold substrate by providing an inclined light source rather than inclining the substrate, as illustrated in FIG. 34. In one such embodiment, an inclined source of UV light may be provided by using substantially cylindrical parabolic light source reflectors which may be angled relative to the vertical to provide an inclined source of UV light. Two exemplary design of such cylindrical parabolic light source reflectors is illustrated in FIG. 35. In one design, the UV light source is collimated in one axis and uncollimated in the other. Such a design may desirably result in an interlocking dry adhesive structure with posts with substantially large overhanging caps, providing a strong adhesion peel strength in one axis, and small overhanging caps and a low adhesion peel strength in the opposite direction. Such a design may be desirably applied for interlocking dry adhesives having large posts where significant undercutting of the caps may occur. In the second design illustrated in FIG. 35, the parabolic reflector collimates light in one axis while a single axis anti-scatter grid under the reflector collimates light in the other axis to produce a higher intensity light than by using a two axis anti-scatter grid alone. Such a design may be desirably applied for interlocking dry adhesives having small fibers which may be better exposed using collimated UV light.

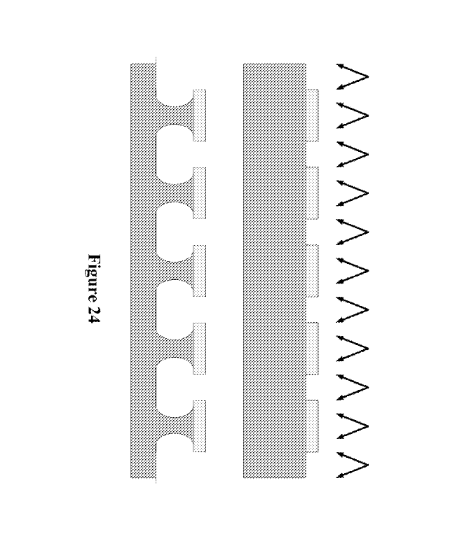

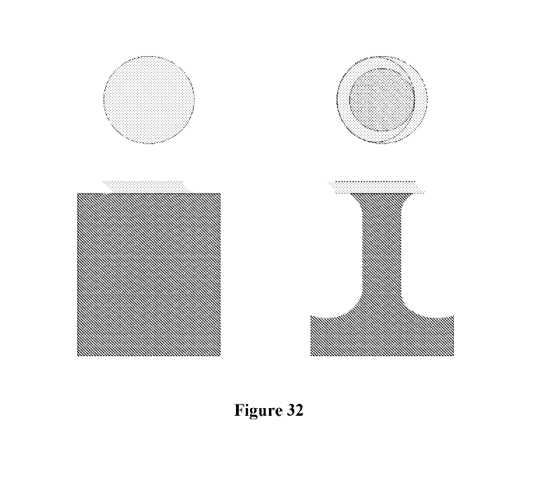

In one embodiment, one or more interlocking caps (and preferably a substantially evenly distributed portion of the caps) of a mold (and the resulting interlocking dry adhesive) may be made substantially thicker than the remaining caps, such as two or more times as thick as illustrated in FIGS. 20 and 28, for example. In such an embodiment, such thick caps may desirably prevent the dry adhesive from normally adhering to surfaces unless it is pressed against a surface with sufficient preload force so as to compress the fiber of the thicker caps, and bring the remaining caps into contact with the surface to adhere. In such an embodiment, the size, shape and density of the thicker “nonstick” fibers and caps may be varied to control the magnitude of preload force required in order to adhere the dry adhesive structure to a surface. In a similar alternative embodiment, alternatively, fibers without caps which are of similar height to capped fibers may be interspersed with the capped fibers in the mold and dry adhesive structure, such as to provide further resistance against adhesion of caps until a preload force is applied to press the caps into contact with the surface.

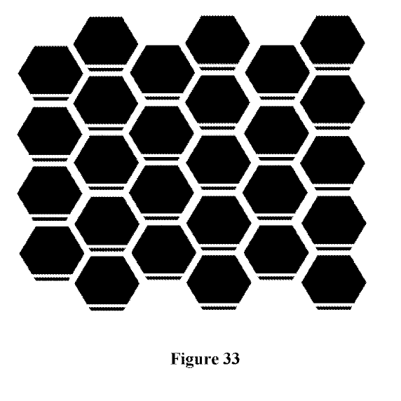

In another embodiment, one or more, or substantially all of the caps may be provided with an elevated rim around the cap, to provide a “suction-cup” shape to the SU-8 caps, as shown in FIG. 29. Such design may optionally provide another dry adhesive variant which requires the application of a preload force in order to adhere to a surface such as by pressing the central portion of the cap into contact with the surface, for example. In an optional embodiment, such “suction-cup” design may also provide additional adhesion strength due to the effect of suction, or may optionally be modified such as having another substance placed or attached in the “suction-cup” center of the cap, such as a soft gel, oil, or tacky material such as to provide additional adhesion properties.

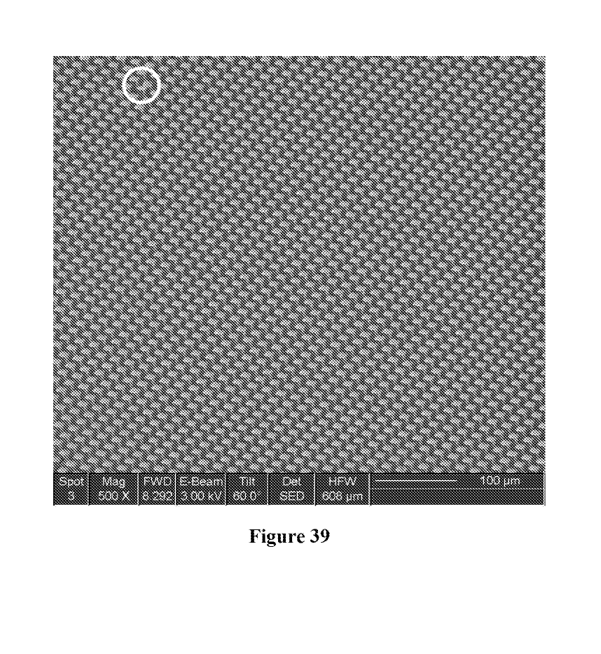

In a further embodiment, such as for applications in environments where contamination with liquids such as water may occur, a superhydrophobic interlocking dry adhesive structure may be provided by using a fiber comprising one or more protrusions along its length, as illustrated in FIG. 36, for example. Such design may further desirably provide for resistance against fiber collapse such as by strengthening the fiber, and/or by reducing the potential for fibers to adhere to one another following collapse, which may provide more rapid recovery of collapsed fibers.

In yet a further embodiment, a thermoplastic interlocking dry adhesive structure according to an embodiment of the present invention may be manufactured from a thermoplastic dry adhesive material which is natively hydrophobic. In one such embodiment, a natively hydrophobic thermoplastic dry adhesive material may desirably provide for improved interlocking dry adhesive structure function for adhering to surfaces in a humid, wet or underwater environment, as may be useful in many water-prone applications. In a particular embodiment, a thermoplastic interlocking dry adhesive structure formed from a natively hydrophobic thermoplastic dry adhesive material may desirably provide for improved underwater adhesion to many surfaces, and may desirably not rely upon suction or related mechanisms for adhesion. In another particular embodiment, a natively hydrophobic thermoplastic interlocking dry adhesive structure may be desirably formed from a SEBS type thermoplastic with relatively hydrophobic native properties, as may be desired for certain wet or underwater applications, for example.

In another embodiment, a non-directional interlocking dry adhesive structure is provided with a cap shape that has a ratio of overhang to tip thickness sufficient to both preload the entire supporting fiber and distribute the load close to but not entirely to the perimeter of the cap when pulled off of a surface. This tip shape may desirably result in the maximum possible adhesion pressure and the lowest probability of encountering a defect on the tip (defined as an area that is not in contact with another surface) that reduces the adhesion significantly from the theoretical maximum. For low modulus dry adhesive materials, this cap shape may desirably be bounded by a ratio of approximately 1:1 for thickness to overhang, and with a maximum overhang for the material to spontaneously recover if the cap is folded into contact with the underlying fiber, or in contact with the top of the cap. The exact optimal dimension for this desired force condition to be achieved may be defined by the modulus of the material and its surface energy. Higher modulus and lower surface energy adhesive materials may have a smaller ratio of thickness to overhang for optimal dimensions. Every scale of fiber from nano/micro/macro scale may desirably have a shape that is optimal for both preloading the fiber and minimizing vulnerability to peeling that may be determined according to the stiffness/adhesion properties of the material.

In another embodiment, a dry adhesive material that is a composite with individual stiff particles larger than the minimum tip dimensions of an individual fiber may be used to produce an interlocking dry adhesive structure. This may desirably stiffen the fiber stalk and bulk material, yet keep the stiff particles embedded within the fiber away from the tip where they may negatively affect adhesion. In a further embodiment, a dry adhesive structure may be produced using a material to produce dry adhesive fibers where the material modulus at the fiber tip is significantly less than those of the underlying bulk material and remaining length of the fiber. Specifically a variation of this design may be provided where only the top surface of the cap is of a lower modulus material than the bulk material. Such a dry adhesive structure may desirably allow fibrillar surfaces to adhere better to lower modulus surfaces and materials such as skin, or organs, for example. One potential application of such an embodiment may be for use as an effective bandage material, for example, whereby unlike standard dry adhesives, such a material may be used only once but may still have the benefits of contact splitting and providing air access to the underlying skin/flesh such as for more rapid healing.

In another embodiment, an interlocking dry adhesive structure may be provided which comprises an adhesive material with at least one integrated smart material which may be adapted to alter one or more of the mechanical stiffness, surface energy, viscoelasticity or geometry of the dry adhesive structure during use to desirably increase or reduce adhesion properties. Such incorporated smart materials may desirably provide for control of the adhesion properties of dry adhesive structures such as by varying temperature, magnetic or electric fields, electrical current, pneumatic or hydraulic pressure, or other control means. In a particular embodiment, a thermoplastic interlocking dry adhesive structure may be molded from a suitable thermoplastic shape memory polymer material, to provide interlocking dry adhesive structures in a thermoplastic shape memory polymer. In one such particular embodiment, the shape memory polymer material may desirably have at least a dual-shape memory effect, wherein an interlocking dry adhesive structure formed from the shape memory polymer material may be deformed into a temporary shape and may later recover its permanent or original shape in response to an external stimulus or trigger. In one such embodiment, the external stimulus for recovery of the permanent or original shape may comprise exposure to at least one of temperature gradient (heating or cooling), electrical or magnetic field, optical or radiation exposure, and chemical triggers, for example. In a particular such embodiment, a shape memory polymer interlocking dry adhesive structure may desirably deform and recover between configurations which improve or deter adhesion at different temperatures, for example, to desirably provide for temperature controlled adhesion properties, or to allow for cleaning or anti-contamination properties such as by providing for adhesion at one temperature, and for releasing dust or contamination from the dry adhesive structure at another temperature, for example.

Alternatively, in a further embodiment, the flexible negative mold used to cast the interlocking dry adhesive structure may be modified such as by electrically charging the mold to impart a permanent electrostatic charge on cast adhesive materials to help bring individual fibers into contact with a surface. Similarly, in another embodiment, a mold may be provided in which the curing of the cast dry adhesive material may be selectively inhibited, such as by use of an inhibiting agent embedded in specific mold locations which may reduce the crosslinking density of the cured adhesive material at the tops/caps of fibers, as may be desirable to provide a tacky adhesion surface of the dry adhesive structure without affecting the quality and/or strength of the bulk adhesive material, for example. In another embodiment, a flexible negative mold for molding interlocking dry adhesive structures may be made from a shape memory polymer material such as to desirably provide for increased mold durability by means of self-healing properties of selected shape memory polymer materials, for example.

### Direct Molding Embodiment for Dry Adhesive Structures with Anisotropic Peel Strength

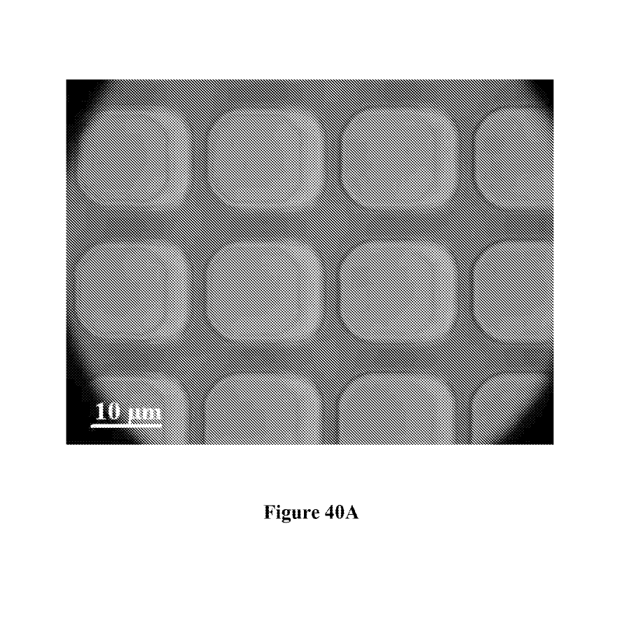

The following several embodiments of the present invention relate to the direct molding of interlocking dry adhesive structures on a photoresist mold, and to dry adhesive structures exhibiting anisotropic peel strengths which may be manufactured by such direct molding methods. In one embodiment, any suitable desired dry adhesive material may be used to directly mold such interlocking dry adhesive structures, including but not limited to: epoxies, silicones, polyurethanes, natural and artificial rubbers polyimides, silicone rubbers (polydimethylsiloxane, polyvinylsiloxane, etc.), flexible and semi-flexible polyurethanes, polystyrenes, thermoplastic elastomers (including styrenic thermoplastic block copolymers such as styrene-ethylene/butylene-styrene (SEBS) including Kraton G1657 and/or G1645, styrene-butadiene-styrene (SBS), styrene-ethylene/propylene-styrene (SPS), ethylene vinyl acetate (EVA), shape memory thermoplastic polymers, and polyolefin elastomer materials, for example), fluoroelastomers (Viton®, Kalrez® etc.), fluorosilicone rubbers and polysulfide rubbers, for example. In a particular exemplary embodiment only, the structural material used to produce dry adhesives according to several embodiments of the present invention as described below may comprise a silicone such as a Sylgard® 184 silicone from Dow Chemical which is a platinum catalyzed silicone that has been used in a wide variety of MEMS applications. To produce the mold for direct molding of this silicone, a two level photoresist stack was used, based on an undercutting layer of polymethylglutarimide (PMGI) such as available from Microchem, and AZ 9260 photoresist. Both materials are positive acting photoresists, although the PMGI is insensitive to i-line (365 nm) exposures. AZ 400K developer diluted 1:4 in water was primarily used for developing the AZ 9260, followed by MF-319 developer to produce the desired undercut in PMGI. These photoresist materials may be desirably used because they are compatible with one another, easily spin coated in a variety of thicknesses, and most importantly, neither significantly inhibit the cure of the Sylgard® 184 when it is molded in the photoresist mold. Additionally, the PMGI can have its dissolution rate altered by exposing it to 254 nm light, allowing an undercut size and shape to be well defined using lift-off processing techniques. In an embodiment of the present invention, patterned areas are exposed to define general undercut shape and location in the PMGI and may be used to define the undercut shape and location independently of the shape or size of the photoresist holes. A diagram showing the basic fabrication procedure is shown in FIG. 37.

A general fabrication process according to an embodiment of the present invention allows a very large number of variations for PMGI and photoresist thickness, which in turn require fine-tuning of process parameters. The following is a description of a manufacturing process according to an embodiment of the present invention, which may be used to produce an exemplary anisotropic interlocking dry adhesive according to another embodiment of the invention, whose behavior is detailed in the later sections:
1. A 4″ silicon wafer is coated with a bi-layer of chrome/gold such as by using a Corona Vacuum Systems sputterer. The gold may prevent silicone adhesion to the substrate, but PMGI adheres well to it. In another alternative embodiment, another metal or coating other than chrome/gold and which is suitable to reduce silicone adhesion to the substrate may be used.
2. A suitable PMGI material, such as PMGI SF slow series 19 (such as may be purchased from Microchem) may be diluted 1:1 by weight in PMGI thinner. The combined mixture may be spun on the wafer (such as to form a PMGI material thickness of about 1-2 μm). In one embodiment, the mixture may be spun onto the wafer at 900 rpm for 30 seconds, and then followed by a 1 minute softbake at 100° C. and a 3 minute hardbake at 190° C. on a hotplate, for example. In one such embodiment, the resulting final PMGI thickness may desirably be approximately 1.5 μm.
3. A thin layer of S1813 photoresist may be spun on the PMGI layer, such as at 3000 rpm for 30 seconds, followed by baking such as for one minute at 100° C. Following spin coating, the photoresist layer may then be exposed to any suitable features that define the cap size and shape for the desired dry adhesives. It may then be developed such as for 30 seconds in MF-319 to produce a mask for subsequent 254 nm exposure.
4. The wafer may be exposed to 254 nm light (such as from a Stratalinker 2400 light source), and with a suitable exposure such as a dose of 0.5 J. Afterwards, the photoresist may be stripped in acetone, and the wafer may be dried off.
5. AZ 9260 or another suitable photoresist material may then be spun onto the wafer, such as at 3000 rpm for 30 seconds, and left to sit such as for at least 5 minutes to relax the film. After relaxing, the wafer may be baked such as at 100° C. for 90 seconds on a hotplate. The total resulting thickness may be approximately 10.5 μm on average.
6. The wafer may be rehydrated for 30 minutes such as in de-ionized water. This may be desirable for complete development of the AZ9260 photoresist.
7. The wafer may be dried off such as in N2 gas, and then exposed to i-line UV light, such as for 50 seconds at a nominal power of 23 mW/cm².
8. Development of the wafer may be completed by immersing it in AZ 400K developer diluted 1:4 with deionized water such as for 6 minutes at 18° C. ambient temperature, followed by a rinse, such as in de-ionized water and a transfer to MF-319 developer for 3 minutes.
9. After the desired undercut is formed, the wafer may be rinsed again in de-ionized water, followed by an N2 dry. The mold may be left at least 1 hour before PDMS may be used for molding.
10. Sylgard® 184 may be mixed at a ratio of 10:1 prepolymer to catalyst, and degassed such as for 30 minutes under vacuum, or alternatively another suitable dry adhesive material may be used. Afterwards, it may be poured or otherwise suitably cast (including such as by thermocompression/extrustion/injection casting) on the photoresist mold and spun on slowly such as until the PDMS is spread to the edge of the wafer. The mold may then be degassed such as for 1 hour under vacuum.
11. Curing of PDMS may be done such as for at least 12 hours at 50° C., followed by demolding. After the PDMS is demolded, a post-cure bake such as at 120° C. for 60 minutes may be used to increase the strength of the PDMS before adhesion tests.

Careful alignment of the two photoresist layers is desirably achieved for fabrication according to the methods of the present invention. PMGI is nearly transparent, and exposed features are not typically visible under high magnification on the aligner. Although it is possible to have previously patterned alignment markers such as in the Au/Cr layer, which has been used in earlier work with transparent structural layers according to one embodiment, in another embodiment an alternative solution may be to leave the wafer in MF-319 developer a little longer than 30 seconds when patterning the thin photoresist prior to 254 nm exposure. In such embodiment, the small developed depth of the PMGI (˜50-100 nm) may then visible under the AZ 9260 photoresist for future alignment to features. Because the strength of the adhesive is so dependent on the exact placement of the caps, the collimation of the aligner is a significant factor in achieving a large field of adhesives with equal properties using the fabrication methods and technologies according to the present invention. If collimation is not good, high aspect ratio features may be radially misaligned and adhesive properties may be consistent over a much smaller portion of the wafer. Once fabricated, the mold can be used multiple times. If alignment is not acceptable, the mold may be stripped in acetone and MF-319 and the wafer may be reused as necessary.

In an alternative embodiment, a suitable thermoplastic dry adhesive material which is compatible with the mold material(s) may be used to thermoplastically cast an interlocking dry adhesive structure directly on the mold by application of heat and pressure, in alternative to exemplary steps 10 and 11. In one such alternative embodiment, compression, extrusion and/or injection molding techniques may be used to cast the suitable thermoplastic dry adhesive material directly into the master mold, and to de-mold the resulting interlocking dry adhesive structure following cooling of the thermoplastic dry adhesive material, for example.

### Several Embodiments with Varied Geometries

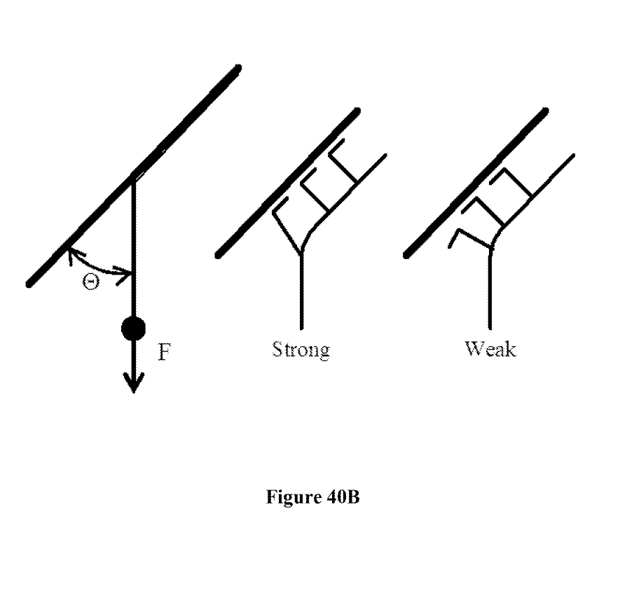

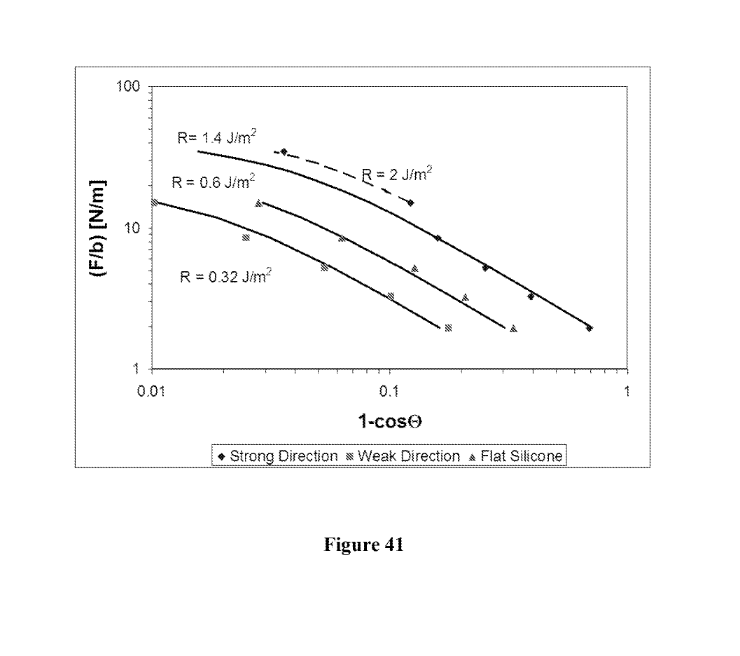

To test a wider variety of anisotropic interlocking dry adhesive geometry variations, the two masks according to embodiments of the invention were produced using either square or rectangular geometries. The primary purpose of this geometry was to ensure that one side would have a very long interface with minimal cap overhang to maximize the differences between adhesion when loading in different directions. Additionally, the cap geometry was rectangular, while the post geometry was set as a square, so that selective misalignments in different directions would result in a much larger range of potential fiber geometries than simply two circles. Another potential benefit to the square post designs is that fill factors of the adhesives can be much higher than for circular posts which should increase the total adhesion. Although there may be an increased likelihood of fiber collapse while using square fibers, earlier theoretical work has indicated that there would be negligible benefits for using a circular fiber rather than a rectangular fiber with equal cross-sectional dimensions. Although the structures fabricated in this work had 10 μm fiber heights, the mold thickness may be increased for other variations. FIG. 38 shows optical and SEM images of 20 μm tall fibers with equal cap size but different post dimensions that were fabricated on the same wafer, according to an embodiment of the invention. The cap size, and top post dimensions may be found from the optical images such as by using an optical micrometer (an Olympus OSM-D4 for example). In both these variations one side has a relatively smaller and preferably substantially no overhang which provides a large perimeter that is vulnerable to peeling. Demolding of the fibers shown in FIG. 38a may preferably be done starting from the side with the largest overhang to prevent cap tearing. When cured properly, these post designs may preferably show substantially no incidence of collapse at aspect ratios up to about 2:1, as shown in FIG. 39 according to another embodiment.

### Testing of Several Embodiments

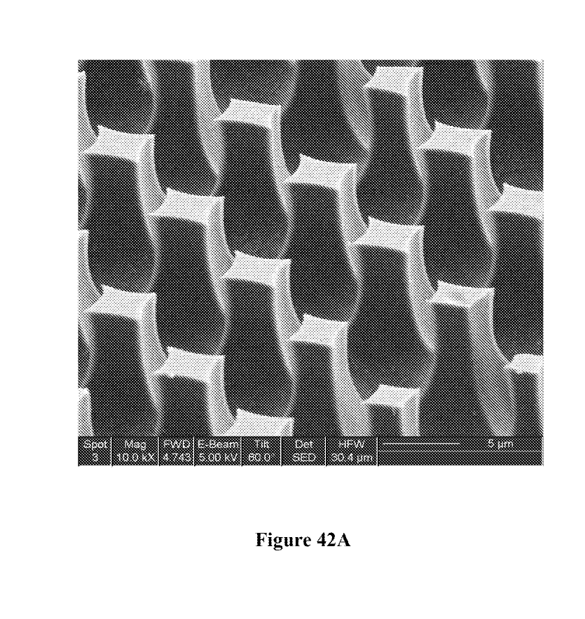

To test the peel strengths of the anisotropic dry adhesives according to an embodiment of the invention, we used a test system based on the Kendall model of peeling (as expressed in the reference by K. Kendall: “Thin-film peeling—the elastic term,” Journal of Physics D, Applied Physics, vol. 8, 1975), which allows us to determine how strong the adhesive force of the anisotropic dry adhesive structure is when loaded in multiple orientations. An exemplary silicone interlocking dry adhesive sheet used for testing in the present embodiment was 9 cm long, 15 mm wide, and 350 μm thick, however other dimensions and specifications may be used in other embodiments of the invention. The geometry of the cap and schematic of the exemplary test setup is shown in FIGS. 40a) and 40b) respectively.

The adhesive strip was attached to a glass slide (previously cleaned in ultrasonic acetone and de-ionized water) mounted to a rotary stage in a vertical orientation. A weight was clipped onto the end of the adhesive and the stage was slowly rotated until the onset of peeling and the equilibrium angle was recorded. The peeling tests were completed 5 times for each weight in each adhesive orientation. The peel strength, R is estimated from the Kendall model of peeling (as described in K. Kendall, “Thin-film peeling—the elastic term,” Journal of Physics D, Applied Physics, vol. 8, 1975, the contents of which are hereby incorporated by reference) where F is the applied force, b is the width of the adhesive, d is the adhesive thickness, E is Young's modulus, and Θ is the peeling angle:

$${( \frac{F}{b} )}^{2} \frac{1}{2 Ed} + ( \frac{F}{b} ) ( 1 - cos Θ ) - R = 0 \qquad ( 1 )$$

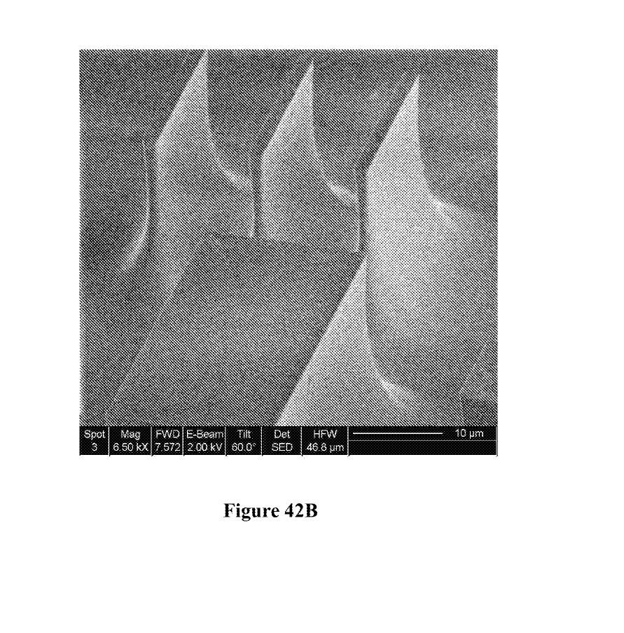

The peel strength is found by fitting this model to the experimental data, and was determined for an exemplary adhesive according to one embodiment when loaded in its strong and weak direction, as well as the back side of the exemplary adhesive strip, which provided the peel strength of an exemplary unstructured silicone processed with the same steps. The resulting behavior for the anisotropic behavior along with peel strength is shown in FIG. 41. Young's modulus was estimated to be about 2 MPa.

The theoretical model fits the experimental data obtained for tests of an exemplary embodiment of the adhesive according to the invention quite well, with the exception of the exemplary adhesive loaded in the strong direction with large weights. In this case, the peel strength appears to have improved with the increased load—a desirable result.

In one embodiment, such behavior may potentially be due to increased shear forces on each fiber during these large loads shifting the location of maximum force on the fiber to an area closer to the large overhanging cap. As this cap may be more tolerant of flaws and crack initiation, it may result in a stronger (such as ˜50% greater) peel strength than when the exemplary sample is loaded lightly. Another very interesting result is that the tested fibers show anisotropic peel strength at all loading values, with lower strength than flat silicone for the weak direction and higher strength than flat silicone for the strong direction. Optimization of the cap overhang and other dimensions of exemplary interlocking adhesive embodiments may be determined by further experimentation, for example.

### Discussion of Several Embodiments

The fabrication methods according to embodiments of the invention, and as described above, may be capable of producing an exemplary anisotropic interlocking adhesive, but the performance may not be the same as an actual gecko. Earlier work on whole toe and individual setae of geckos has demonstrated what is termed to be frictional adhesion, where the normal adhesive force that a gecko produced is related to the shear force applied to the toe or setae. A benefit to this adhesion method is that when the shear load is removed, there will be substantially no normal adhesion and the animal can remove its foot from a surface with ease. Qualitatively, anisotropic adhesives according to embodiments of the present invention as described above may not behave in this manner, as they may remain on smooth surfaces under small perpendicular loads in the absence of shear.

There are several potential reasons for this difference in behavior. Unlike the gecko, the interlocking dry adhesives according to certain embodiments of the present invention may be made of a relatively soft material that exhibits significant normal and peel adhesion strength even when unstructured and the minimum adhesive force under pure normal loading may be inherently greater. A second difference between adhesive behaviors is that the gecko foot hairs are angled prior to loading and require shear force to put them all in contact. If the fiber tips of dry adhesives according to certain embodiments of the present invention were tilted, they might also be expected to demonstrate behavior closer to gecko frictional adhesion.

Further improvement to the dry adhesives according to one embodiment of the present invention may involve optimizing the tip size and offset, as well as increasing the fiber heights.

### Further Microstructured Material Embodiments

Microfluidics, smart materials, and biomimetic surfaces such as interlocking dry adhesive structures according to embodiments of the present invention may all desirably benefit from the cost reductions and substrate size increases available when using hybrid micromanufacturing technologies adapted to large scale manufacturing, such as roll to roll continuous manufacturing processes, for example. Micro and nano-fabrication has traditionally been based on silicon, glass and other inorganic materials, owing to its history as an offshoot of the microelectronics industry. However, many new microstructured products, such as smart surfaces and materials, cannot be commercially viable when limited by the size of a typical silicon wafer and/or limited by small scale batch processes. The focus of traditional microfabrication and lithography is to reduce the size of minimum features in order to pack more devices on a single chip, but there is very little research on batch microfabrication on very large areas. For many applications. such as microfluidics, feature sizes on the order of 5-10 μm may be acceptable, but device sizes may desirably be several square centimeters at minimum. The production of low-cost microfluidics using polymers promises great savings in costs, reaction times and consumed materials when applied to drug testing, biological analysis and chemical reactions. Unfortunately, large-scale commercialization of these devices is held back in part by existing manufacturing methods which are designed for inorganic materials, and don't take advantage of casting, stamping, direct printing, injection molding and other fabrication options that have made polymers and plastics so ubiquitous for macroscale applications. Polymer MEMS and microfabrication requires a leap in manufacturing technologies to enhance traditional lithography with large-scale substrates and low-cost materials. The growing capability of industrial fabrication technologies to approach the feature sizes previously only achievable by lithography has opened up many new possibilities for producing hybrid micro/macro products using polymers that are beyond the capability of traditional silicon MEMS.

In one embodiment of the invention, large-scale micro-patterned smart materials and polymer based microsystems may be produced, such as by new microfabrication technologies that borrow from other manufacturing industries and modify traditional lithography to manufacture microsystems on industrial scales. Although microfluidics, MEMS and micropatterned surfaces have all been produced using traditional lithography on silicon or glass substrates, part of the limitation in mass producing these products has been the limited substrate sizes—a maximum of 30 cm diameter disks in the case of silicon. While the complexity and power per unit area of integrated circuits has increased dramatically over the last two decades, products like labs-on-chip and MEMS devices cannot be reduced in size as easily while still being effective for chemical synthesis or biological analysis. Fundamentally, integrated circuits design can benefit from further reduction of features and chip size, while biological and chemical applications are presently better served by reducing the cost per area of relatively large chips and dies. Other applications for polymer micromachining, such as self-cleaning superhydrophobic surfaces or biomimetic interlocking dry adhesives according to embodiments of the present invention, only require one or two patterned layers, simplifying alignment processes and allowing much larger areas to be patterned in a single step. Polymer micromachining on large substrates, or with newer technologies like roll-to-roll processing can fill a manufacturing niche that neither traditional microfabrication nor industrial manufacturing has properly addressed.

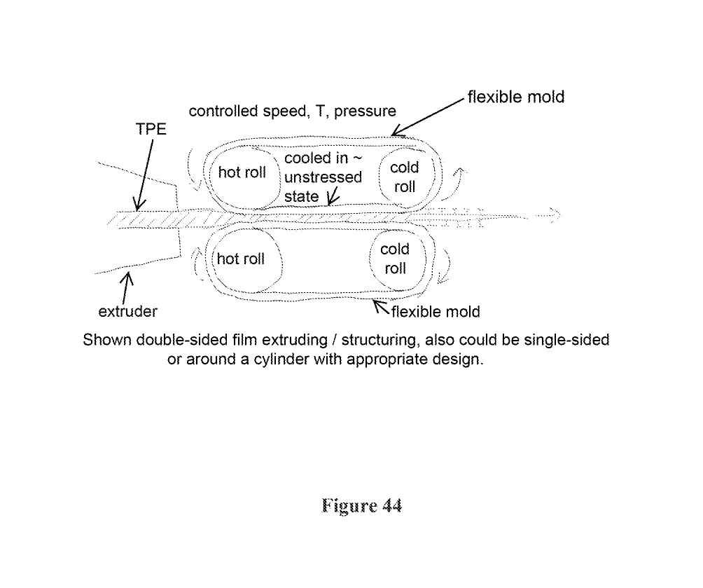

In another embodiment of the present invention a roll-to-roll processing method may be adapted for producing interlocking dry adhesive structures from thermoplastic polymer and/or thermoplastic elastomer materials, wherein a flexible negative mold may be used to mold the thermoplastic material by means of a suitable compression, extrusion or injection molding procedure. In such a compression, extrusion or injection molding procedure, preferably both heat and pressure are applied to the thermoplastic material such as to heat the thermoplastic above a higher critical glass transition temperature or above a critical polymer flow temperature and to force the thermoplastic material into the flexible negative mold under pressure. Subsequent manufacturing steps according to an embodiment of the invention may desirably include a cooling step to cool the thermoplastic dry adhesive material below a glass transition temperature of at least one component of the thermoplastic material (may be passive and/or actively cooled steps) and a de-molding step to separate the final interlocking dry adhesive structure. FIG. 44 illustrates an exemplary roll-to-roll processing method using thermoplastic dry adhesive materials where the thermoplastic material is extruded in a film, and thereby passes between one or more rolls or drums where the casting, cooling and de-molding steps may desirably be conducted on the one or more rolls or drums, such that the roll-to-roll manufacturing method may desirably be conducted in a substantially continuous fashion, thereby desirably increasing productivity and decreasing costs of production for interlocking dry adhesive structures, for example.

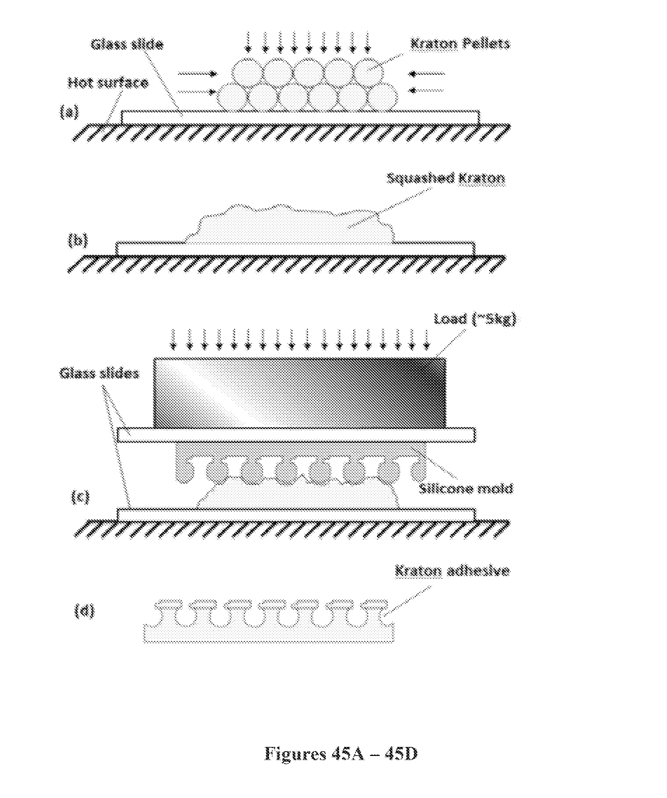

Referring to FIGS. 45A to 45D, a schematic view of an exemplary compression molding method for producing interlocking microstructures in a heated thermoplastic polymer by compression and/or injection molding of the thermoplastic polymer in a flexible mold is illustrated, according to a particular embodiment of the present invention. In one such method, a first step as shown in FIG. 45A may comprise providing a suitable flexible thermoplastic polymer dry adhesive material (including styrenic thermoplastic block copolymers such as styrene-ethylene/butylene-styrene (SEBS) including Kraton G1657 and/or G1645, styrene-butadiene-styrene (SBS), styrene-ethylene/propylene-styrene (SPS), ethylene vinyl acetate (EVA), shape memory thermoplastic polymers, and polyolefin elastomer materials, for example), such as an exemplary styrene-ethylene-butylene-styrene (SEBS) elastomer such as Kraton G1657 and/or Kraton G1645, for example. In a particular such embodiment, a suitable thermoplastic elastomer material such as Kraton G1657 and/or Kraton G1645 may be provided as resin pellets and may be heated and/or melted to a desired molding temperature, such as on a glass surface at 200 C for example. In one such method, a second step as shown in FIG. 45B may comprise compressing the thermoplastic elastomer material to produce a melted thermoplastic puck or mass on the glass surface. A third step as shown in FIG. 45C may then comprise molding a suitable flexible negative mold (such as a flexible silicone negative dry adhesive structure mold formed by a suitable photolithographic process such as described in detail above) comprising negative interlocking dry adhesive microstructure features into the melted thermoplastic puck or mass by application of a desired molding pressure for a desired molding time, such as from 30 seconds to 2-3 minutes and more particularly about 1 minute, for example, as may be required to completely form the particular thermoplastic elastomer material into the flexible negative mold. In one such embodiment, a static load may be applied on top of the flexible negative mold and the melted thermoplastic puck or mass held between glass plates and on top of a heated surface such as a hotplate, such as to apply a compressive molding pressure of about 2-10 psi, and more particularly about 3-4 psi for example, as may be required by a particular desired thermoplastic material in order to fully mold the desired interlocking dry adhesive structure features from the flexible negative mold into the melted thermoplastic material. In one embodiment, a fourth step following molding may comprise allowing the thermoplastic material to cool, and flexibly demolding the flexible negative mold such as by peeling from the thermoplastic material, to yield the finished thermoplastic interlocking dry adhesive structure, as shown in FIG. 45D, for example.

One embodiment of the present invention comprises advanced micro-manufacturing technologies and development of new composites and functional polymer materials for future integration with large-scale manufacturing techniques, such as for applications in polymer based microfluidic systems, flexible sensors, and biomimetic dry adhesives. In another embodiment, polymer MEMS may be produced such as for use in biological and ‘wet’ applications, or for direct contact with the ambient environment for long periods of time. An advantage of polymer MEMS and microfabrication according to embodiments of the present invention is the potential for large-scale patterning. By avoiding silicon entirely and using either thin sheets or flexible films of plastic as substrates, large areas of microstructures can be produced such as by combining standard lithography techniques along with advanced soft lithography technologies for applications ranging from MEMS and microfluidics to smart surfaces and intelligent materials.

### Manufacturing Embodiments Using Industrial Polymers

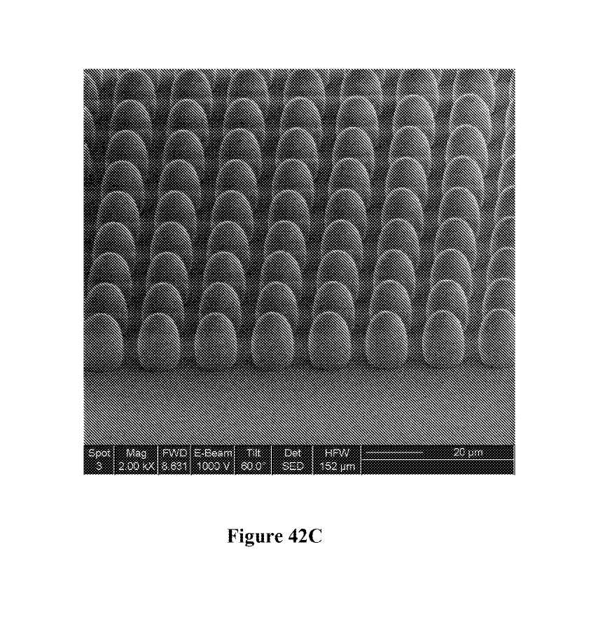

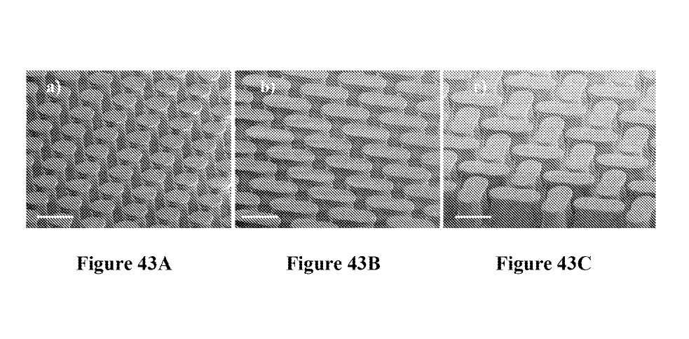

Acrylic composed primarily of polymethylmethacrylate (PMMA) is one of the most widely used MEMS polymers and may be patterned using a variety of methods, including e-beam lithography, x-ray lithography, hot embossing, dry etching and laser ablation, but is substantially insensitive to most standard UV wavelengths used in MEMS photolithography. Recently, novel techniques using an uncollimated 254 nm exposure of commercial acrylic have proven viable for producing microfluidic channels. While the original use for this patterning method was for very thin layers of PMMA, the penetration depth at this wavelength in commercial acrylics can be several hundred micrometers, allowing the definition of deep structures without requiring expensive x-ray sources or dry etching technology. Through modification of commercially available large area 254 nm light sources like those used for DNA crosslinking or water purification, the effects of different additives, molecular weights and developers on the quality, reliability and yield of large area PMMA lithography may be applied to develop bulk polymer micromachining processes. A potential benefit of this technology is to convert low aspect ratio patterning through direct printing or stamping, or lithography into high aspect ratio features over very large areas (such as several square feet). Given the fabrication versatility of PMMA, embodiments of the invention may incorporate colloidal nano-lithography, and laser ablation to produce features ranging from nano to macroscale in a single process. Applications for such processes may include large-scale microfluidic fabrication technology with both high resolution and variable channel depths, and as polymer molds for casting microstructured surfaces in elastomers like polydimethylsiloxane (PDMS), or polyurethanes, such as illustrated in the exemplary surface structures of FIGS. 42A, 42B and 42C. FIGS. 43A, 43B and 43C illustrate further exemplary dry adhesive fiber and cap shapes and geometries according to an embodiment of the present invention.

While commercial acrylic is a highly attractive material for large-scale micromachining, other polymers like polycarbonate, polystyrene and epoxies may also be implemented as large-scale microstructured materials in further embodiments.

### Further Dry Adhesive Embodiments

Further embodiments of the present invention are directed to replicating the function of the feet of geckos with respect to their remarkable climbing capabilities. Hierarchal fibrillar structures on gecko feet split contact between millions of nanoscale fiber tips and climbing surfaces to produce adhesion through van der Waals interactions. The benefits to these adhesives include self-cleaning capabilities, superhydrophobic behavior, anisotropic (direction sensitive) adhesive strength, and long-term stability. One embodiment of the present invention is directed to manufacturing these materials on large scales with high yields, and correctly modeling their behavior for macroscale applications. In one embodiment, testing results on these adhesives indicate the existence of an optimal interlocking cap geometry for a given fiber material and size, and the critical importance of understanding peel failure behavior for microscale fibers. Although existing models of dry adhesive behavior work well for individual fibers or small areas under loads, they fail to account for inhomogeneous and tangential loading, or the probability of microscale defects reducing adhesive strength per fiber.

Further embodiments may be directed to varying the adhesive strength by varying fiber geometries, material properties, surface energies and environmental conditions. Yet a further embodiment provides a standardized test procedure for these materials that includes both micro and macroscale testing for peel, normal and shear strengths on smooth surfaces and materials with well-defined roughness. Specific contamination modes, cleaning procedures and long-term adhesion tests may also be provided to determine effects on macroscale adhesion performance, as that will be the most important for any real-world applications of these materials.

### Polymer MEMS Composite Embodiments

A drawback for conventional polymer MEMS is that electronic integration can be quite difficult. Although it is possible to adequately bond metals to some polymers for subsequent wirebonding and electrical packaging, the process is highly dependent on material surface properties, glass transition temperature and polymer thickness. In one embodiment provided, polymer MEMS devices may be provided incorporating nanopowders added to bulk polymers to add electrical and magnetic functionality to spin-coated, cast or injection molded polymer microstructures. In another embodiment, electrically conductive or magnetic composites may be used by themselves or integrated with metallic components for use with active polymer MEMS sensors and actuators and have the potential advantage to be printed or cast in arbitrary shapes and layouts. Nanopowders may be added to bulk polymers to add electrical and/or magnetic functionality to different materials, for example. Further embodiments provide for the manufacturing, testing, and application of novel composite materials to polymer MEMS and to integrate these materials into sensors and actuators embedded in smart skins and biomimetic surfaces, for example.

The exemplary embodiments herein described, including what is described in the Abstract, are not intended to be exhaustive or to limit the scope of the invention to the precise forms disclosed. They are chosen and described to explain the principles of the invention and its application and practical use to allow others skilled in the art to comprehend its teachings. As will be apparent to those skilled in the art in light of the foregoing disclosure, various equivalent alterations and modifications are possible in the practice of this invention without departing from the scope of the disclosure.

Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Further, the described features, structures, or characteristics of the present disclosure may be combined in any suitable manner in one or more embodiments. In this Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

The scope of the present disclosure fully encompasses other embodiments and is to be limited, accordingly, by nothing other than the appended claims, wherein any reference to an element being made in the singular is intended to mean “one or more”, and is not intended to mean “one and only one” unless explicitly so stated. All structural and functional equivalents to the elements of the above-described preferred embodiment and additional embodiments are hereby expressly incorporated by reference and are intended to be encompassed by the present claims. Moreover, no requirement exists for an apparatus or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, are also encompassed by the present disclosure.

What is claimed is:

1. A method of manufacturing an interlocking dry adhesive structure comprising overhanging cap and undercut fiber structures, the method comprising:
providing a flexible elastomer negative mold comprising negative interlocking dry adhesive structures comprising a plurality of negative overhanging cap and undercut fiber structures;
molding a thermoplastic dry adhesive polymer material in said flexible elastomer negative mold under application of heat and pressure;
allowing said thermoplastic dry adhesive polymer material to cool; and
flexibly demolding said flexible elastomer negative mold from said thermoplastic dry adhesive polymer material to release said interlocking dry adhesive structure comprising said overhanging cap and undercut fiber structures.

2. The method of manufacturing an interlocking dry adhesive structure according to claim 1 wherein said thermoplastic dry adhesive polymer material comprises at least one material selected from the list comprising: thermoplastic elastomers, styrenic thermoplastic block copolymers, styrene-ethylene/butylene-styrene (SEBS) elastomers, Kraton G1657, Kraton G1645, styrene-butadiene-styrene (SBS) elastomers, styrene-ethylene/propylene-styrene (SPS) elastomers, ethylene vinyl acetate (EVA) elastomers, shape memory thermoplastic polymers, and polyolefin elastomer materials.

3. The method of manufacturing an interlocking dry adhesive structure according to claim 1, additionally comprising melting a thermoplastic dry adhesive polymer material before molding said thermoplastic dry adhesive polymer material in said flexible elastomer negative mold under application of heat and pressure.

4. The method of manufacturing an interlocking dry adhesive structure according to claim 1, wherein said molding comprises at least one of compressive molding, injection molding and extrusion molding.

5. The method of manufacturing an interlocking dry adhesive structure according to claim 1, wherein molding said thermoplastic dry adhesive polymer material additionally comprises providing a thermoplastic dry adhesive polymer material in a pellet form and melting said melting a thermoplastic dry adhesive polymer material.

6. The method of manufacturing an interlocking dry adhesive structure according to claim 1, wherein molding said thermoplastic dry adhesive polymer material additionally comprises heating said thermoplastic dry adhesive polymer material to between 160 C and 230 C.

7. The method of manufacturing an interlocking dry adhesive structure according to claim 1, wherein molding said thermoplastic dry adhesive polymer material additionally comprises heating said thermoplastic dry adhesive polymer material to about 20° C.

8. The method of manufacturing an interlocking dry adhesive structure according to claim 1, wherein molding said thermoplastic dry adhesive polymer material comprises applying a molding pressure of between 2 psi and 10 psi to said thermoplastic dry adhesive polymer material.

9. The method of manufacturing an interlocking dry adhesive structure according to claim 1, wherein said flexible elastomer negative mold comprising negative interlocking dry adhesive structures comprises a roller comprising a flexible elastomer negative mold roll.

10. The method of manufacturing an interlocking dry adhesive structure according to claim 9, wherein said molding comprises providing an extruded film of a thermoplastic dry adhesive polymer material, and molding said thermoplastic dry adhesive polymer material in said flexible elastomer negative mold roll under application of heat and pressure.

11. The method of manufacturing an interlocking dry adhesive structure according to claim 1, wherein said providing additionally comprises providing a master mold substrate comprising a plurality of said overhanging cap and undercut fiber structures, and molding a flexible elastomer material in said master mold substrate to provide said flexible elastomer negative mold.

12. The method of manufacturing an interlocking dry adhesive structure according to claim 11, wherein said providing further comprises patterning and developing a photoresistive master mold material to provide said master mold substrate comprising said plurality of said overhanging cap and undercut fiber structures.

13. A thermoplastic interlocking dry adhesive structure comprising overhanging cap and undercut fiber structures formed by the method according to claim 1.

14. A method of manufacturing a thermoplastic interlocking dry adhesive structure comprising overhanging cap and undercut fiber structures, the method comprising:
applying a photoresistive material to a photosensitive mold substrate comprising polymethyl methacrylate;
patterning and developing said photoresistive material to form a mask comprising said overhanging cap structures corresponding to the dry adhesive structure;
exposing said mask and said photoresistive mold substrate to UV light to pattern said photoresistive mold substrate;
developing said mold substrate to form said undercut fiber structures substantially aligned with and supporting said overhanging cap structures corresponding to the dry adhesive structure;
molding a flexible elastomer material in said mold substrate to form a flexible elastomer negative mold comprising a plurality of negative overhanging cap and undercut fiber structures; and
molding a thermoplastic polymer dry adhesive material in said flexible elastomer negative mold under heat and pressure to form said thermoplastic interlocking dry adhesive structure comprising said overhanging cap and undercut fiber structures.

15. The method of manufacturing a thermoplastic interlocking dry adhesive structure according to claim 13, wherein said UV light is at least partially collimated.

16. The method of manufacturing a thermoplastic interlocking dry adhesive structure according to claim 13, wherein said thermoplastic dry adhesive polymer material comprises at least one material selected from the list comprising: thermoplastic elastomers, styrenic thermoplastic block copolymers, styrene-ethylene/butylene-styrene (SEBS) elastomers, Kraton G1657, Kraton G1645, styrene-butadiene-styrene (SBS) elastomers, styrene-ethylene/propylene-styrene (SPS) elastomers, ethylene vinyl acetate (EVA) elastomers, shape memory thermoplastic polymers, and polyolefin elastomer materials.

17. The method of manufacturing a thermoplastic interlocking dry adhesive structure according to claim 13, wherein said patterning and developing the photoresistive material to form a mask comprises patterning comprising at least one of: direct printing, stamping and lithography.

18. The method of manufacturing an interlocking dry adhesive structure according to claim 13, wherein said molding said thermoplastic polymer dry adhesive material comprises at least one of compressive molding, injection molding and extrusion molding.

19. A thermoplastic interlocking dry adhesive structure comprising overhanging cap and undercut fiber structures formed by the method according to claim 13.

20. A thermoplastic interlocking dry adhesive structure consisting of a flexible thermoplastic polymer material and comprising:
a base structure;
a plurality of undercut fiber structures extending from said base structure and having an aspect ratio of at least 1:1; and
a plurality of overhanging cap structures corresponding to and situated atop said undercut fiber structures wherein said overhanging cap structures substantially overhang said undercut fiber structures on at least one side.
